(19) United States
(12) Patent Application Publication
(10) Pub. No.: US 2024/0161422 A1
(43) Pub. Date: May 16, 2024

(54) ELECTRONIC DEVICE FOR PROVIDING AT LEAST ONE MULTIMEDIA CONTENT TO USERS ACCESSING OBJECT AND METHOD THEREOF

(71) Applicant: SAMSUNG ELECTRONICS CO., LTD., Suwon-si (KR)

(72) Inventors: Sanghun LEE, Suwon-si (KR); Jaewon BANG, Suwon-si (KR); Donghyun YEOM, Suwon-si (KR); Moonsoo CHANG, Suwon-si (KR)

(73) Assignee: SAMSUNG ELECTRONICS CO., LTD., Suwon-si (KR)

(21) Appl. No.: 18/234,189

(22) Filed: Aug. 15, 2023

Related U.S. Application Data
(63) Continuation of application No. PCT/KR23/11174, filed on Jul. 31, 2023.

(30) Foreign Application Priority Data
Nov. 11, 2022 (KR) 10-2022-0150796
Nov. 18, 2022 (KR) 10-2022-0155806

(51) Int. Cl. G06T 19/00; G02B 27/01; G06V 10/762

(52) U.S. Cl. CPC G06T 19/006; G02B 27/0172; G06V 10/762; G02B 2027/0178

(57) ABSTRACT

According to an embodiment, a processor of a wearable device displays a first visual object associated with a position viewed through Field of View (FoV) of a first user. The processor obtains, based on identifying an external electronic device connected to the wearable device, a state of the external electronic device. The processor identifies, based on the state of the external electronic device corresponding to a preset state for displaying a visual object associated with the position, a cluster common to the first user and a second user of the external electronic device. The processor adjusts, based on the identified cluster, the first visual object viewed through the FoV to a second visual object indicated by the cluster.

### CROSS-REFERENCE TO RELATED APPLICATIONS

This application is a bypass continuation application, under 35 U.S.C § 111(a), of International Application No. PCT/KR2023/011174 designating the United States, filed on Jul. 31, 2023, in the Korean Intellectual Property Receiving Office, which claims priority from Korean Patent Application No. 10-2022-0150796, filed on Nov. 11, 2022, and Korean Patent Application No. 10-2022-0155806, filed on Nov. 18, 2022, in the Korean Intellectual Property Office, the disclosures of which are hereby incorporated by reference herein in their entireties.

### BACKGROUND

### 1. Field

The disclosure relates to an electronic device and a method performed by the electronic device, and in particular, an electronic device and a method for providing at least one multimedia content to users accessing an object.

### 2. Description of Related Art

In order to provide an enhanced user experience, an electronic device that provides an augmented reality (AR) service are being developed. For example, the AR service provided by the electronic device includes displaying information generated by a computer in association with an external object in the real-world. The electronic device may be a wearable device that may be worn by a user. For example, the electronic device may be AR glasses and/or a head-mounted device (HMD).

### SUMMARY

According to an embodiment, there is provided a wearable device. The wearable device may include a display; a communication circuit, and a processor. The processor may be configured to control the display to display a first visual object associated with a position viewed through field-of-view (FoV) of a first user wearing the wearable device. The processor may be configured to obtain a state of a first external electronic device connected to the wearable device through the communication circuit, the first external electronic device associated with a second user. The processor may be configured to identify, based on the state of the first external electronic device corresponding to a first state for displaying a visual object associated with the position, a first cluster common to the first user and the second user. The processor may be configured to control the display, based on the identified first cluster, to change from displaying the first visual object viewed through the FoV to display a second visual object corresponding to by the first cluster.

According to an embodiment, there is provided a method of an electronic device. The method may include obtaining, based on identifying a first external electronic device accessing to a first position for outputting multimedia content through a communication circuit of an electronic device, a plurality of first clusters corresponding to the first external electronic device. The method may include transmitting, to the first external electronic device, information for outputting first multimedia content associated with the first position and corresponding to a first cluster among the plurality of first clusters. The method may include obtaining, based on identifying a second external electronic device accessing to the first position, a plurality of second clusters corresponding to the second external electronic device. The method may include transmitting, based on identifying a second cluster commonly included in the plurality of first clusters and the plurality of second clusters, to the first external electronic device and the second external electronic device, information for outputting second multimedia content associated with the first position and corresponding to the second cluster.

According to an embodiment, there is provided a method of a wearable device. The method may include displaying a first visual object associated with a position viewed through field-of-view (FoV) of a first user wearing the wearable device through a display of the wearable device. The method may include obtaining a state of a first external electronic device connected to the wearable device through a communication circuit, the first external electronic device associated with a second user. The method may include identifying, based on the state of the first external electronic device corresponding to a first state for displaying a visual object associated with the position, a first cluster common to the first user and the second user of the external electronic device. The method may include changing, based on the first cluster, from displaying the first visual object viewed through the FoV to displaying a second visual object corresponding to the first cluster.

According to an embodiment, an electronic device may comprise a communication circuit and a processor. The processor may be configured to obtain, based on identifying a first external electronic device accessing to a first position for selectively outputting multimedia content through a communication circuit, a plurality of first clusters corresponding to the first external electronic device. The processor may be configured to, transmit, to the first external electronic device, information for outputting first multimedia content associated with the first position, and corresponding to a first cluster among the plurality of first clusters. The processor may be configured to obtain, based on identifying a second external electronic device accessing to the first position, a plurality of second clusters corresponding to the second external electronic device. The processor may be configured to, based on identifying a second cluster commonly included in the plurality of first clusters and the plurality of second clusters, transmit, to the first external electronic device and the second external electronic device, information for outputting second multimedia content associated with the first position and corresponding to the second cluster.

### BRIEF DESCRIPTION OF DRAWINGS

FIG. 1 is an exemplary diagram of an environment in which an AR service is provided through a server according to an embodiment.

FIG. 2 is an exemplary diagram of an environment in which an AR service is provided through a direct connection between user terminals and a second terminal according to an embodiment.

FIG. 3A illustrates an example of a perspective view of a wearable device according to an embodiment.

FIG. 3B illustrates an example of one or more hardware provided in a wearable device according to an embodiment.

FIGS. 4A and 4B illustrate an example of the appearance of a wearable device according to an embodiment.

FIG. 5 illustrates an example of an operation in which wearable devices, according to an embodiment, display multimedia content based on a relationship between users corresponding to the wearable devices.

FIG. 6 is a block diagram of a wearable device and a server connected to the wearable device according to an embodiment.

FIG. 7 illustrates an example of an operation in which a wearable device displays multimedia content based on a virtual space according to an embodiment.

FIG. 8 illustrates an example of an operation of selecting multimedia content to be provided to the users based on a relationship between users corresponding to wearable devices, according to an embodiment.

FIGS. 9A and 9B illustrate an example of an operation in which wearable devices display multimedia content based on a relationship between users corresponding to the wearable devices, according to an embodiment.

FIGS. 10A, 10B and 10C illustrate an example of a timing diagram indicating an order in which wearable devices output multimedia content according to an embodiment.

FIG. 11 illustrates an example of a flowchart including a wearable device and an operation of a server connected to the wearable device according to an embodiment.

FIG. 12 illustrates an example of a flowchart including an operation of an electronic device, according to an embodiment.

FIG. 13 illustrates an example of a flowchart including an operation of a server connected to a wearable device, according to an embodiment.

### DETAILED DESCRIPTION

Hereinafter, various embodiments of the present document will be described with reference to the accompanying drawings.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Metaverse is a combination of the English words Meta, which means “virtual” and “transcendence,” and “Universe,” which means the universe, and refers to a three-dimensional virtual world where social, economic, and cultural activities like the real world take place. Metaverse is a concept that has evolved one step further than virtual reality, and it is characterized by using avatars to not only enjoy games or virtual reality (VR, cutting-edge technology that enables people to experience real-life experiences in a computerized virtual world), but also social and cultural activities like real reality.

Such a metaverse service may be provided in at least two forms. The first form is to provide services to users by using a server, and the second form is to provide services through individual contacts between users.

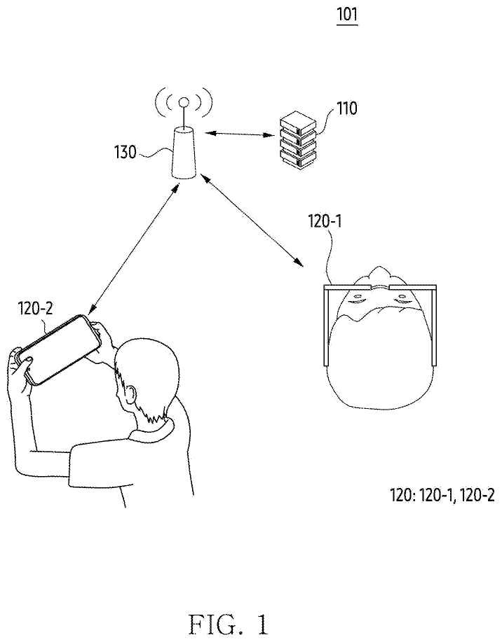

FIG. 1 is an exemplary diagram of an environment 101 in which an AR service is provided through a server 110 according to an embodiment. However, the disclosure is not limited to AR service, but may include virtual reality, and/or mixed reality services. According to an embodiment, the AR service may be a metaverse service.

Referring to FIG. 1, the environment 101 include a server 110 providing a metaverse service, a network (e.g., a network formed by at least one intermediate node 130 including an access point (AP) and/or a base station) connecting the server 110 and each of the user terminal (e.g., a user terminal 120 including a first terminal 120-1 and a second terminal 120-2), a user terminal that enable the use of services by accessing the server through the network and providing input and output to the metaverse service to the user.

In this case, the server 110 provides a virtual space so that the user terminal 120 may perform an activity in the virtual space. In addition, the user terminal 120 installs an S/W agent for accessing the virtual space provided by the server 110 to represent the information provided by the server 110 to the user or transmits the information that the user wants to represent in the virtual space to the server.

The S/W agent may be directly provided through the server 110 or downloaded from a public server, or may be embedded when purchasing a terminal.

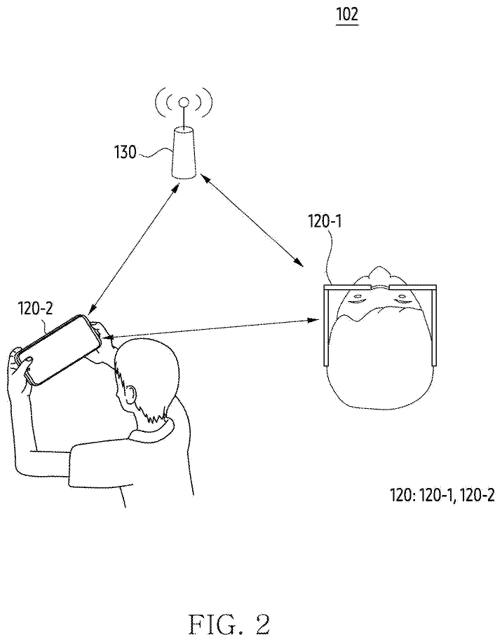

FIG. 2 is an exemplary diagram of an environment 102 in which an AR service is provided through direct connection between user terminals and a second terminal (e.g., a first terminal 120-1 and a second terminal 120-2) according to an embodiment. According to an embodiment, the AR service may be a metaverse service.

Referring to FIG. 2, the environment 102 includes a first terminal 120-1 providing a metaverse service, a network connecting each user terminal (e.g., a network formed by at least one intermediate node 130), and a second terminal 120-2 that allows a second user to use the service by inputting/outputting to the metaverse service by connecting to the first terminal 120-1 through the network.

According to the embodiment illustrated in FIG. 2, the first terminal 120-1 provides a metaverse service by performing the role of a server (e.g., the server 110 in the embodiment illustrated in FIG. 1) in the embodiment. That is, it may be seen that the metaverse environment may be configured only by connecting the device to the device.

In the embodiments illustrated in FIGS. 1 and 2, the user terminal 120 (or the user terminal 120 including the first terminal 120-1 and the second terminal 120-2) may be made of various form factors, and is characterized in that it includes an output device that provides an image or/and sound to a user and an input device for inputting information into a metaverse service. Examples of various form factors of the user terminal 120 may include a smartphone (e.g., the second terminal 120-2), an AR device (e.g., the first terminal 120-1), a VR device, an MR device, a VST device, or TV or projector capable of input/output, and the like.

The network of the present invention (e.g., a network formed by at least one intermediate node 130) includes all of various broadband networks including 3G, 4G, and 5G and a short-range network (e.g., a wired network or wireless network directly connecting the first terminal 120-1 and the second terminal 120-2) including Wi-Fi, BT, and the like.

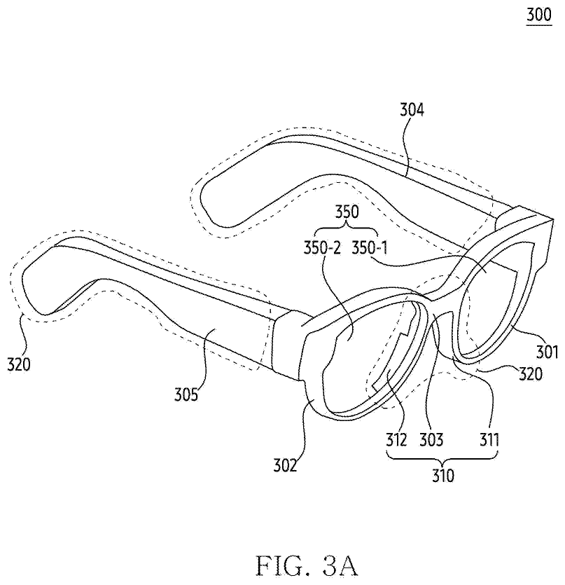

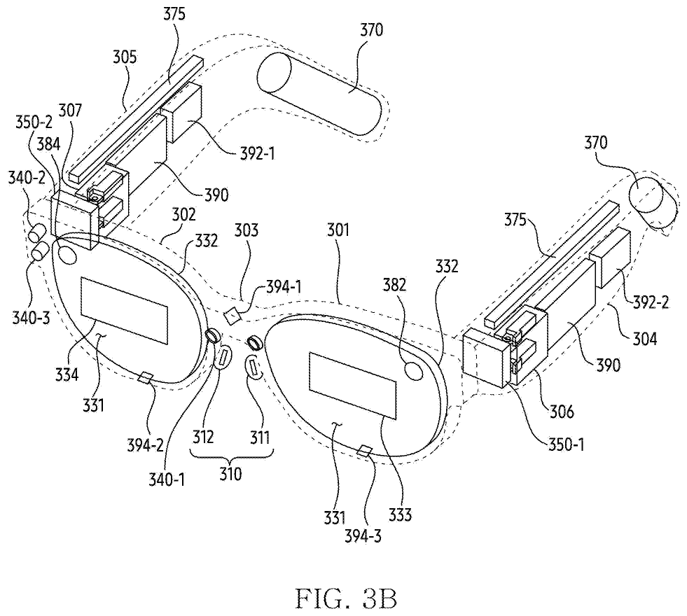

FIG. 3A illustrates an example of a perspective view of a wearable device 300 according to an embodiment. FIG. 3B illustrates an example of one or more hardware provided in a wearable device 300 according to an embodiment. The wearable device 300 of FIGS. 3A to 3B may include the first terminal 120-1 of FIGS. 1 to 2. As shown in FIG. 3A, according to an embodiment, the wearable device 300 may include at least one display 350 and a frame supporting the at least one display 350.

According to an embodiment, the wearable device 300 may be wearable on a portion of the body of the user. The wearable device 300 may provide augmented reality (AR), virtual reality (VR), or mixed reality (MR) combining the augmented reality and the virtual reality to a user wearing the wearable device 300. For example, the wearable device 300 may output a virtual reality image to a user through the at least one display 350 in response to a gesture of the user obtained through a motion recognition camera 340-2 of FIG. 3B. The gesture may be a preset or a predetermined gesture.

According to an embodiment, the at least one display 350 in the wearable device 300 may provide visual information to a user. For example, the at least one display 350 may include a transparent or translucent lens. The at least one display 350 may include a first display 350-1 and/or a second display 350-2 spaced apart from the first display 350-1. For example, the first display 350-1 and the second display 350-2 may be provided at positions corresponding to the left and right eyes, respectively, of the user.

Referring to FIG. 3B, the at least one display 350 may provide another visual information, which is distinct from the visual information, together with the visual information included in the ambient light passing through the lens, a user wearing the wearable device 300, by forming a display area on the lens. The lens may be formed based on at least one of a fresnel lens, a pancake lens, or a multi-channel lens. For example, the display area formed by the at least one display 350 may be formed on the second surface 332 among the first surface 331 and the second surface 332 of the lens. When the user wears the wearable device 300, the ambient light may be transmitted to the user by being incident on the first surface 331 and being penetrated through the second surface 332. For another example, the at least one display 350 may display the virtual reality image to be combined with a real screen transmitted through the ambient light. The virtual reality image output from the at least one display 350 may be transmitted to the eyes of the user through the one or more hardware (e.g., optical devices 382 and 384, and/or at least one waveguides 333 and 334)) included in the wearable device 300.

According to an embodiment, the wearable device 300 may include the waveguides 333 and 334 that diffracts light transmitted from the at least one display 350 and relayed by the optical devices 382 and 384 and transmits it to the user. The waveguides 333 and 334 may be formed based on at least one of glass, plastic, or polymer. A nano pattern may be formed on at least a portion of the outside or inside of the waveguides 333 and 334. The nano pattern may be formed based on a grating structure having a polygonal or curved shape. Light incident to one end of the waveguides 333 and 334 may be propagated to the other end of the waveguides 333 and 334 by the nano pattern. The waveguides 333 and 334 may include at least one of at least one diffraction element (e.g., a diffractive optical element (DOE), a holographic optical element (HOE)), and a reflection element (e.g., a reflection mirror). For example, the waveguides 333 and 334 may be provided in the wearable device 300 to guide a screen displayed by the at least one display 350 to the eyes of the user. For example, the screen may be transmitted to the eyes of the user based on total internal reflection (TIR) generated in the waveguides 333 and 334.

According to an embodiment, the wearable device 300 may analyze an object included in a real image collected through a camera (i.e., a photographing camera 340-3), combine virtual object corresponding to an object that become a subject of augmented reality provision among the analyzed object, and display them on the at least one display 350. The virtual object may include at least one of text and images for various information associated with the object included in the real image. The wearable device 300 may analyze the object based on a multi-camera such as a stereo camera. For the object analysis, the wearable device 300 may execute time-of-flight (ToF) and/or simultaneous localization and mapping (SLAM) supported by the multi-camera. The user wearing the wearable device 300 may watch an image displayed on the at least one display 350.

According to an embodiment, the frame may be configured with a physical structure in which the wearable device 300 may be worn on the body of the user. According to an embodiment, the frame may be configured so that when the user wears the wearable device 300, the first display 350-1 and the second display 350-2 may be positioned corresponding to the left and right eyes of the user. The frame may support the at least one display 350. For example, the frame may support the first display 350-1 and the second display 350-2 to be positioned at positions corresponding to the left and right eyes of the user.

Referring to FIG. 3A, the frame may include an area 320 at least partially in contact with the portion of the body of the user in case that the user wears the wearable device 300. For example, the area 320 in contact with the portion of the body of the user of the frame may include an area contacting a portion of the nose of the user, a portion of the ear of the user, and a portion of the side of the face of the user that the wearable device 300 contacts. According to an embodiment, the frame may include a nose pad 310 that is contacted on the portion of the body of the user. When the wearable device 300 is worn by the user, the nose pad 310 may be contacted on the portion of the nose of the user. The frame may include a first temple 304 and a second temple 305 that is contacted on another portion of the body of the user that is distinct from the portion of the body of the user.

For example, the frame may include a first rim 301 surrounding at least a portion of the first display 350-1, a second rim 302 surrounding at least a portion of the second display 350-2, a bridge 303 provided between the first rim 301 and the second rim 302, a first pad 311 provided along a portion of the edge of the first rim 301 from one end of the bridge 303, a second pad 312 provided along a portion of the edge of the second rim 302 from the other end of the bridge 303, the first temple 304 extending from the first rim 301 and fixed to a portion of the wearer's ear, and the second temple 305 extending from the second rim 302 and fixed to a portion of the ear opposite to the ear. The first pad 311 and the second pad 312 may be in contact with the portion of the nose of the user, and the first temple 304 and the second temple 305 may be in contact with a portion of the face of the user and the portion of the ear of the user. The temples 304 and 305 may be rotatably connected to the rim through hinge units 306 and 307 of FIG. 3B. The first temple 304 may be rotatably connected with respect to the first rim 301 through the first hinge unit 306 provided between the first rim 301 and the first temple 304. The second temple 305 may be rotatably connected with respect to the second rim 302 through the second hinge unit 307 provided between the second rim 302 and the second temple 305. According to an embodiment, the wearable device 300 may identify an external object (e.g., a fingertip of the user) touching the frame and/or a gesture performed by the external object by using a touch sensor, a grip sensor, and/or a proximity sensor formed on at least a portion of the surface of the frame.

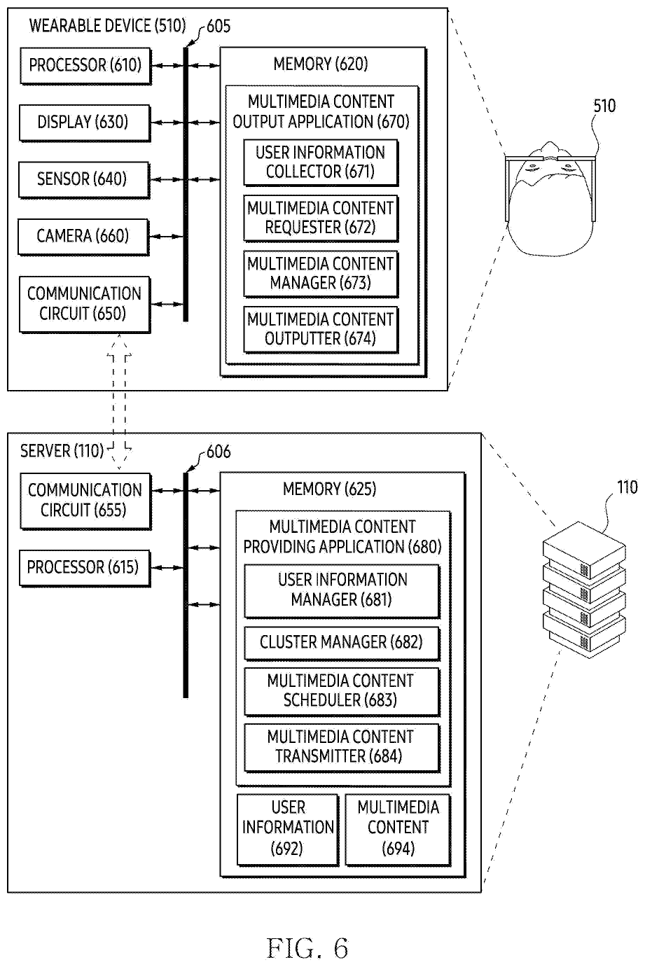

According to an embodiment, the wearable device 300 may include hardware (e.g., hardware described above based on the block diagram of FIG. 6) that performs various functions. For example, the hardware may include a battery module 370, an antenna module 375, the optical devices 382 and 384, speakers 392-1 and 392-2, microphones 394-1, 394-2, and 394-3, a light emitting module, and/or a printed circuit board 390. Various hardware may be provided in the frame.

According to an embodiment, the microphone 394-1, 394-2, and 394-3 of the wearable device 300 may obtain a sound signal, by being provided on at least a portion of the frame. The first microphone 394-1 provided on the nose pad 310, the second microphone 394-2 provided on the second rim 302, and the third microphone 394-3 provided on the first rim 301 are illustrated in FIG. 3B, but the number and disposition of the microphone 394 are not limited to an embodiment of FIG. 3B. In case that the number of the microphone 394 included in the wearable device 300 is two or more, the wearable device 300 may identify the direction of the sound signal by using a plurality of microphones provided on different portions of the frame.

According to an embodiment, the optical devices 382 and 384 may transmit the virtual object transmitted from the at least one display 350 to the waveguides 333 and 334. For example, the optical devices 382 and 384 may be a projector. The optical devices 382 and 384 may be provided adjacent to the at least one display 350 or may be included in the at least one display 350 as portion of the at least one display 350. The first optical device 382 may correspond to the first display 350-1, and the second optical device 384 may correspond to the second display 350-2. The first optical device 382 may transmit the light output from the first display 350-1 to the first waveguide 333, and the second optical device 384 may transmit light output from the second display 350-2 to the second waveguide 334.

In an embodiment, a camera 340 may include an eye tracking camera (ET CAM) 340-1, the motion recognition camera 340-2, and/or the photographing camera 340-3. The photographing camera 340-3, the eye tracking camera 340-1, and the motion recognition camera 340-2 may be provided at different positions on the frame and may perform different functions. The eye tracking camera 340-1 may output data indicating the gaze of the user wearing the wearable device 300. For example, the wearable device 300 may detect the gaze from an image including the pupil of the user obtained through the eye tracking camera 340-1. An example in which the eye tracking camera 340-1 is provided toward the right eye of the user is illustrated in FIG. 3B, but the embodiment is not limited thereto, and the eye tracking camera 340-1 may be provided alone toward the left eye of the user or may be provided toward both eyes of the user.

In an embodiment, the photographing camera 340-3 may capture (or take) a photograph a real image or background to be matched with a virtual image in order to implement the augmented reality or mixed reality content. The photographing camera may capture a photograph an image of a specific object existing at a position viewed by the user and may provide the image to the at least one display 350. The at least one display 350 may display one image in which a virtual image provided through the optical devices 382 and 384 is overlapped with information on the real image or background including an image of the specific object obtained by using the photographing camera. In an embodiment, the photographing camera may be provided on the bridge 303 provided between the first rim 301 and the second rim 302.

In an embodiment, the eye tracking camera 340-1 may implement a more realistic augmented reality by matching the gaze of the user with the visual information provided on the at least one display 350 by tracking the gaze of the user wearing the wearable device 300. For example, when the user looks in front, the wearable device 300 may naturally display environment information associated with the environment front of the user on the at least one display 350 at the position where the user is positioned. The eye tracking camera 340-1 may be configured to capture an image of the pupil of the user in order to determine the gaze of the user. For example, the eye tracking camera 340-1 may receive gaze detection light reflected from the pupil of the user and may track the gaze of the user based on the position and movement of the received gaze detection light. In an embodiment, the eye tracking camera 340-1 may be provided at a position corresponding to the left and right eyes of the user. For example, the eye tracking camera 340-1 may be provided in the first rim 301 and/or the second rim 302 to face the direction in which the user wearing the wearable device 300 is positioned.

In an embodiment, the motion recognition camera 340-2 may provide a specific event to the screen provided on the at least one display 350 by recognizing the movement of the whole or portion of the body of the user, such as the torso, the hand, or the face of the user. The motion recognition camera 340-2 may obtain a signal corresponding to the gesture by recognizing the gesture of the user, and may provide a display corresponding to the signal to the at least one display 350. The processor may identify a signal corresponding to the operation and may perform a preset function based on the identification. In an embodiment, the motion recognition camera 340-2 may be provided on the first rim 301 and/or the second rim 302.

In an embodiment, the camera 340 included in the wearable device 300 is not limited to the above-described eye tracking camera 340-1 and the motion recognition camera 340-2. For example, the wearable device 300 may identify an external object included in the FoV by using the photographing camera 340-3 provided toward the FoV of the user. That the wearable device 300 identifies the external object may be performed based on a sensor for identifying a distance between the wearable device 300 and the external object, such as a depth sensor and/or a time of flight (ToF) sensor. The camera 340 provided toward the FoV may support an autofocus function and/or an optical image stabilization (OIS) function. For example, the wearable device 300 may include the camera 340 (e.g., a face tracking (FT) camera) provided toward the face in order to obtain an image including the face of the user wearing the wearable device 300.

According to an embodiment, the wearable device 300 according to an embodiment may further include a light source (e.g., LED) that emits light toward a subject (e.g., the eyes of the user, the face of the user, and/or the external object in the FoV of the user) photographed by using the camera 340. The light source may include an LED having an infrared wavelength. The light source may be provided on at least one of the frame, and the hinge units 306 and 307.

According to an embodiment, the battery module 370 may supply power to electronic components of the wearable device 300. In an embodiment, the battery module 370 may be provided in the first temple 304 and/or the second temple 305. For example, the battery module 370 may be a plurality of battery modules 370. The plurality of battery modules 370, respectively, may be provided on each of the first temple 304 and the second temple 305. In an embodiment, the battery module 370 may be provided at an end of the first temple 304 and/or the second temple 305.

In an embodiment, the antenna module 375 may transmit the signal or power to the outside of the wearable device 300 or may receive the signal or power from the outside. The antenna module 375 may be electronically and/or operably connected to the communication circuit (e.g., a communication circuit 650 described later with reference to FIG. 6) in the wearable device 300. In an embodiment, the antenna module 375 may be provided in the first temple 304 and/or the second temple 305. For example, the antenna module 375 may be provided close to one surface of the first temple 304 and/or the second temple 305.

In an embodiment, the speakers 392-1 and 392-2 may output a sound signal to the outside of the wearable device 300. A sound output module may be referred to as a speaker. In an embodiment, the speakers 392-1 and 392-2 may be provided in the first temple 304 and/or the second temple 305 in order to be provided adjacent to the ear of the user wearing the wearable device 300. For example, the wearable device 300 may include the second speaker 392-2 provided adjacent to the left ear of the user by being provided in the first temple 304, and the first speaker 392-1 provided adjacent to the right ear of the user by being provided in the second temple 305.

In an embodiment, the light emitting module may include at least one light emitting element. The light emitting module may emit light of a color corresponding to a specific state or may emit light through an operation corresponding to the specific state in order to visually provide information on a specific state of the wearable device 300 to the user. For example, in case that the wearable device 300 needs charging, it may repeatedly emit red light at a preset timing. In an embodiment, the light emitting module may be provided on the first rim 301 and/or the second rim 302.

Referring to FIG. 3B, according to an embodiment, the wearable device 300 may include the printed circuit board (PCB) 390. The PCB 390 may be included in at least one of the first temple 304 or the second temple 305. The PCB 390 may include an interposer provided between at least two sub PCBs. On the PCB 390, one or more hardware included in the wearable device 300 may be provided. The wearable device 300 may include a flexible PCB (FPCB) for interconnecting the hardware.

According to an embodiment, the wearable device 300 may include at least one of a gyro sensor, a gravity sensor, and/or an acceleration sensor for detecting the posture of the wearable device 300 and/or the posture of a body part (e.g., a head) of the user wearing the wearable device 300. Each of the gravity sensor and the acceleration sensor may measure gravity acceleration, and/or acceleration based on preset three-dimensional axes (e.g., x-axis, y-axis, and z-axis) perpendicular to each other. The gyro sensor may measure angular velocity of each of preset three-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 300 may identify the motion of the user and/or gesture performed to execute or stop a specific function of the wearable device 300 based on the IMU.

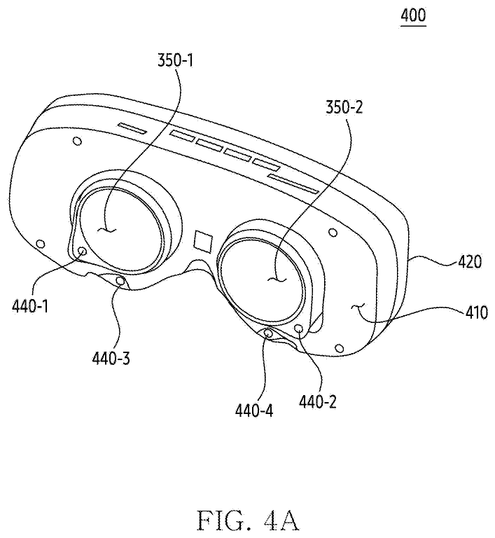

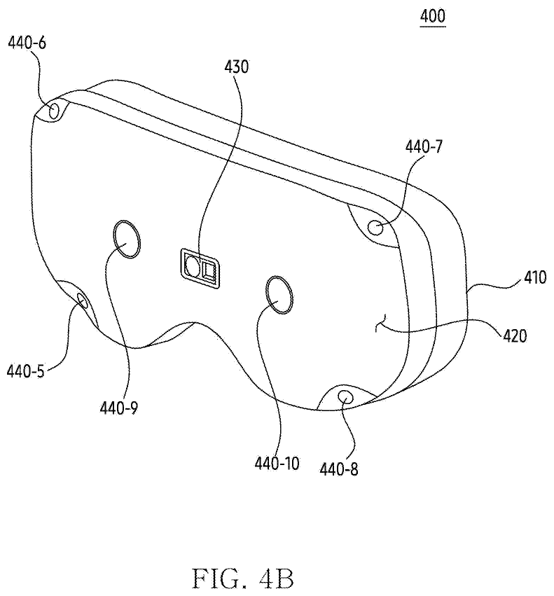

FIGS. 4A and 4B illustrate an example of the appearance of a wearable device 400 according to an embodiment. The wearable device 400 of FIGS. 4A and 4B may include a first terminal 120-1 of FIGS. 1, and 2. According to an embodiment, an example of an appearance of a first surface 410 of the housing of the wearable device 400 may be illustrated in FIG. 4A, and an example of an appearance of a second surface 420 opposite to the first surface 410 may be illustrated in FIG. 4B.

Referring to FIG. 4A, according to an embodiment, the first surface 410 of the wearable device 400 may have a shape configured to be attachable to a body part of a user. For example, the first surface 410 may be contoured to match a shape of a body part of the user. For example, the first surface 410 of the wearable device 400 may have an attachable shape to be worn on the face of the user. According to an embodiment, the wearable device 400 may further include a strap for being fixed on the body part of the user, and/or one or more temples (e.g., a first temple 304 and/or a second temple 305 of FIGS. 3A to 3B). A first display 350-1 for outputting an image to the left eye among both eyes of the user and a second display 350-2 for outputting an image to the right eye among both eyes of the user may be provided on the first surface 410. The wearable device 400 may be formed on the first surface 410 and may further include rubber or silicon packing for preventing interference by light (e.g., ambient light) different from the light emitted from the first display 350-1 and the second display 350-2.

According to an embodiment, the wearable device 400 may include cameras 440-1 and 440-2 for capturing and/or tracking both eyes of the user adjacent to each of the first display 350-1 and the second display 350-2. The cameras 440-1 and 440-2 may be referred to as ET cameras. According to an embodiment, the wearable device 400 may include cameras 440-3 and 440-4 for capturing and/or recognizing the face of the user. The cameras 440-3 and 440-4 may be referred to as FT cameras.

Referring to FIG. 4B, a camera (e.g., cameras 440-5, 440-6, 440-7, 440-8, 440-9, and 440-10), and/or a sensor (e.g., a depth sensor 430) for obtaining information associated with the external environment of the wearable device 400 may be provided on the second surface 420 opposite to the first surface 410 of FIG. 4A. For example, the cameras 440-5, 440-6, 440-7, 440-8, 440-9, and/or 440-10 may be provided on the second surface 420 in order to recognize an external object different from the wearable device 400. For example, by using cameras 440-9, and 440-10, the wearable device 400 may obtain an image and/or video to be transmitted to each of the both eyes of the user. The camera 440-9 may be provided on the second surface 420 of the wearable device 400 to obtain an image to be displayed through the second display 350-2 corresponding to the right eye among the both eyes. The camera 440-10 may be provided on the second surface 420 of the wearable device 400 to obtain an image to be displayed through the first display 350-1 corresponding to the left eye among the both eyes. However, the number of cameras and/or the location of the cameras are not limited to the illustration in FIGS. 4A and 4B. As such, according to an embodiment, the number of cameras and/or the location of the cameras may be different.

According to an embodiment, the wearable device 400 may include the depth sensor 430 provided on the second surface 420 in order to identify a distance between the wearable device 400 and the external object. By using the depth sensor 430, the wearable device 400 may obtain spatial information about at least a portion of the FoV of the user wearing the wearable device 400. According to an embodiment, the spatial information may include, but is not limited to, a depth map.

According to an embodiment, a microphone for obtaining sound output from the external object may be provided on the second surface 420 of the wearable device 400. The number of microphones may be one or more depending on embodiments.

As described above, according to an embodiment, the wearable device 400 may have a form factor for being worn on a head of the user. The wearable device 400 may provide a user experience based on augmented reality, virtual reality, and/or mixed reality in a state of being worn on the head. In conjunction with an object included in at least one display 350 in the wearable device 400, the wearable device 400 may output multimedia content. The multimedia content output in conjunction with the object may be selected based on a relationship between users browsing the object through one or more external electronic devices different from the wearable device 400 and the user wearing the wearable device 400. The multimedia content may be selected by a server (e.g., a server 110 of FIG. 1) for providing a metaverse service based on the object.

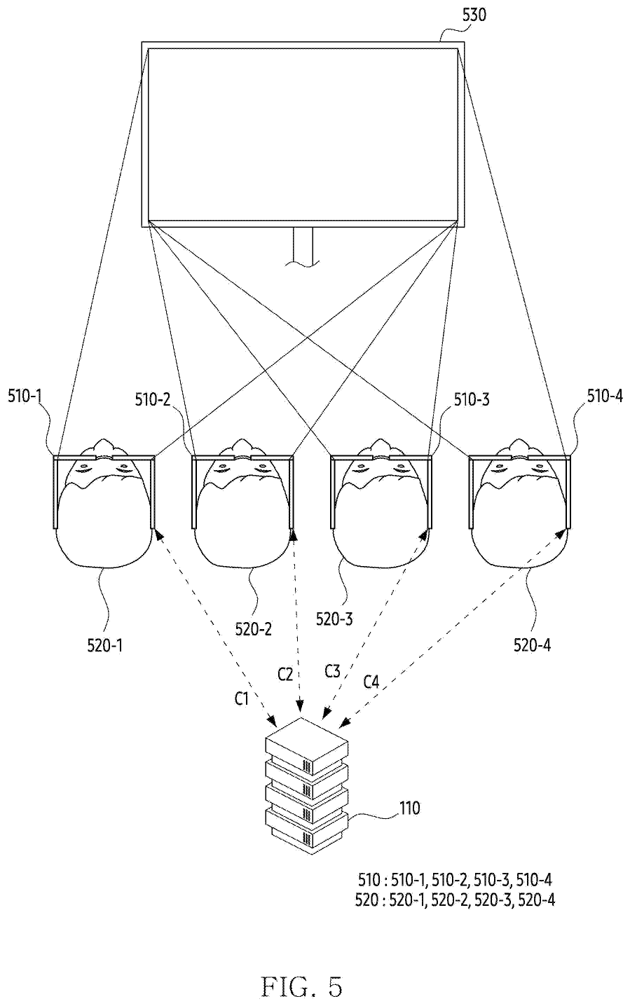

Hereinafter, with reference to FIG. 5, an example of an operation in which the wearable device (e.g., the first terminal 120-1 of FIGS. 1 and 2) including the wearable device 300 of FIGS. 3A and 3B and/or the wearable device 400 of FIGS. 4A and 4B displays the multimedia content will be described.

FIG. 5 illustrates an example of an operation in which wearable devices 510-1, 510-2, 510-3, and 510-4, according to an embodiment, display the multimedia content based on a relationship between users 520-1, 520-2, 520-3, and 520-4 corresponding to the wearable devices 510-1, 510-2, 510-3, and 510-4. A wearable device 510 of FIG. 5 may include a first terminal 120-1 of FIGS. 1 to 2, a wearable device 300 of FIGS. 3A to 3B, and/or a wearable device 400 of FIGS. 4A to 4B. For example, the wearable device 510 may include a head-mounted display (HMD) that is wearable on the user 520's head.

According to an embodiment, the wearable device 510 may display a user interface (UI) in a field-of-view (FoV) of a user 520 in a state worn by the user 520. The UI may be associated with a metaverse service provided by the wearable device 510 and/or a server 110 connected to the wearable device 510. Based on the metaverse service, the wearable device 510 and/or the server 110 may provide the user 520 wearing the wearable device 510 with a UI for enhancing interconnectivity with another user connected through the metaverse service. Referring to FIG. 5, a plurality of wearable devices 510-1, 510-2, 510-3, and 510-4 connected to the metaverse service provided by the server 110 and a plurality of users 520-1, 520-2, 520-3, and 520-4 wearing each of the plurality of wearable devices 510-1, 510-2, 510-3, and 510-4 are exemplarily illustrated. However, the embodiment is not limited thereto.

According to an embodiment, the server 110 may obtain information necessary for outputting the multimedia content to the wearable device 510 from the wearable device 510. An example of hardware included in the server 110 and the wearable device 510 to exchange information will be described with reference to FIG. 6. The information may include first information corresponding to a position, an orientation and/or direction of the wearable device 510. For example, the information may include, but is not limited to size and/or direction of FoV of the user 520 wearing the wearable device 510. The information may include second information associated with the user 520 logged into the wearable device 510. For example, the second information may include, but is not limited to user information, account information, and/or profile information of the user 520. The information may include third information on an external environment including the wearable device 510 identified through a sensor (e.g., camera) of the wearable device 510. Referring to FIG. 5, the server 110 may obtain information on FoVs of a plurality of wearable devices 510-1, 510-2, 510-3, and 510-4 from a plurality of wearable devices 510-1, 510-2, 510-3, and 510-4.

In an embodiment, the multimedia content output through the wearable device 510 may be associated with the metaverse service provided through the server 110. The multimedia content may include an image, video, text, or a combination thereof to display an advertisement. As the multimedia content is output through the wearable device 510, the wearable device 510 may generate a signal for stimulating at least one of the five senses of the user 520. The server 110 may transmit information for reproducing the multimedia content to the wearable device 510. Based on the information, the wearable device 510 may visualize the multimedia content in the FoV of the user 520, may output an audio signal included in the multimedia content, and/or may output haptic feedback based on the multimedia content. The advertisement is illustrated as an example of the multimedia content, but the embodiment is not limited thereto. As such, according to an embodiment, the multimedia content may include an electronic book and/or a movie different from the advertisement.

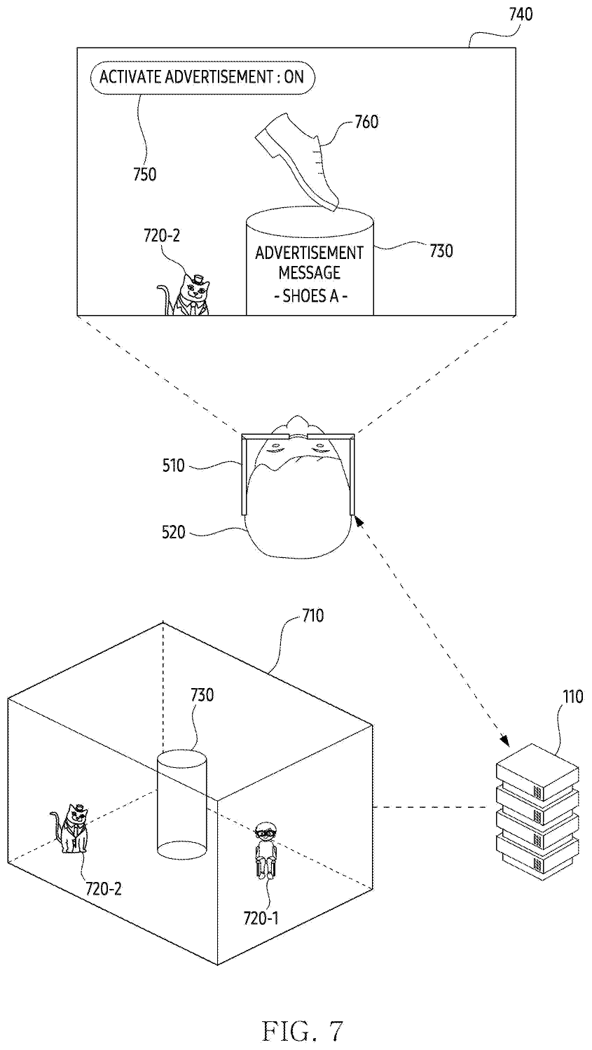

Referring to FIG. 5, an exemplary case in which all of the plurality of wearable devices 510-1, 510-2, 510-3, and 510-4 are provided facing an external object 530 is illustrated. The external object 530 may include a real object as a landmark such as a building, a billboard, and/or an electric display. The external object 530 may be provided in the external environment of the wearable device 510 for displaying the multimedia content based on AR and/or MR. The external object 530 may be registered in the server 110 for selective output of the multimedia content based on server 110. In case that the external object 530 is the real object, the server 110 may transmit information for outputting the multimedia content in association with the external object 530 to one or more external electronic devices (e.g., a plurality of wearable devices 510-1, 510-2, 510-3, and 510-4) in an area and/or position where the external object 530 may be viewed. The embodiment is not limited thereto, and the external object 530 may include a virtual object matched to a coordinate system of the real world for displaying the multimedia content based on VR and/or MR. The operations of the server 110 and the wearable device 510 based on the virtual object will be described with reference to FIG. 7.

In an embodiment, based on information received from the plurality of wearable devices 510-1, 510-2, 510-3, and 510-4, the server 110 may identify the external object 530 shown through the FoVs of a plurality of users 520-1, 520-2, 520-3, 520-4, and 520-4, wearing the plurality of wearable devices 510-1, 510-2, 510-3, and 510-4. For example, based on whether the external electronic device accesses a preset position for selective output of the multimedia content based on the external object 530, the server 110 may determine whether to display the multimedia content associated with the external object 530 through the external electronic device. Referring to FIG. 5, the server 110 may identify the plurality of wearable devices 510-1, 510-2, 510-3, and 510-4 accessing the preset position.

In an embodiment, based on identifying the plurality of wearable devices 510-1, 510-2, 510-3, and 510-4 accessing the preset position, the server 110 may identify clusters corresponding to each of the plurality of wearable devices 510-1, 510-2, 510-3, and 510-4. The cluster may mean a group for displaying the multimedia content. The cluster may be a unit for providing a substantially matched multimedia content experience. A cluster may be matched to one multimedia content. That a plurality of electronic devices are included in one cluster may mean that the server 110 transmits information for displaying the multimedia content matched to the cluster, to the plurality of electronic devices. The server 110 may identify one or more clusters by grouping a plurality of external electronic devices (e.g., the plurality of wearable devices 510-1, 510-2, 510-3, and 510-4) connected to the server 110 and/or a plurality of users logged into the plurality of external electronic devices. For example, the server 110 may identify one or more clusters matching a specific external electronic device.

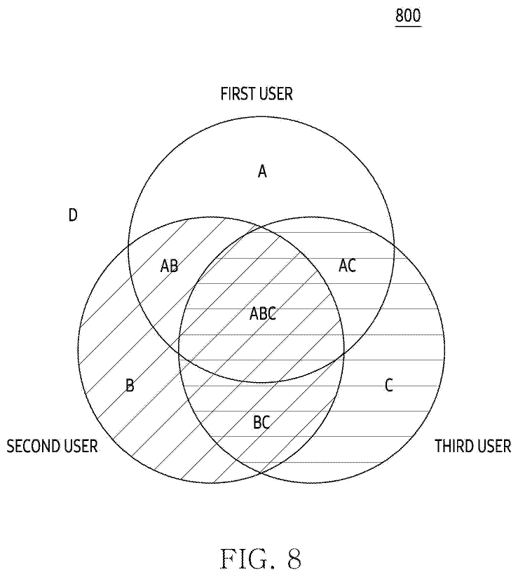

In an embodiment, the server 110 may transmit the information for displaying the multimedia content corresponding to a cluster included in each of the plurality of wearable devices 510-1, 510-2, 510-3, and 510-4 to the plurality of wearable devices 510-1, 510-2, 510-3, and 510-4 accessing the external object 530. In case that the plurality of wearable devices 510-1, 510-2, 510-3, and 510-4 are included in different clusters, the server 110 may individually transmit information to display different multimedia contents corresponding to different clusters to each of the plurality of wearable devices 510-1, 510-2, 510-3, and 510-4. In case that the plurality of wearable devices 510-1, 510-2, 510-3, and 510-4 are included in the same cluster, the server 110 may transmit information to display the multimedia content corresponding to the cluster to the plurality of wearable devices 510-1, 510-2, 510-3, and 510-4. An example of an operation in which the server 110 transmits the information for displaying the multimedia content to the external electronic devices based on clusters matched to the external electronic devices will be described with reference to FIG. 8.

Referring to FIG. 5, in the exemplary case of classifying each of the plurality of wearable devices 510-1, 510-2, 510-3, and 510-4 into different clusters, the server 110 may transmit the multimedia content corresponding to each of the clusters to the plurality of wearable devices 510-1, 510-2, 510-3, and 510-4. The first wearable device 510-1 receiving information for displaying multimedia content C1 may display the multimedia content C1 in association with the external object 530 in the FoV of the first user 520-1 wearing the first wearable device 510-1. The second wearable device 510-2 may display multimedia content C2 overlapping the external object 530 in the FoV of the second user 520-2. Each of the third wearable device 510-3 and the fourth wearable device 510-4 may display each of the FoVs of the third user 520-3 and the fourth user 520-4, respectively, multimedia content C3, and multimedia content C4.

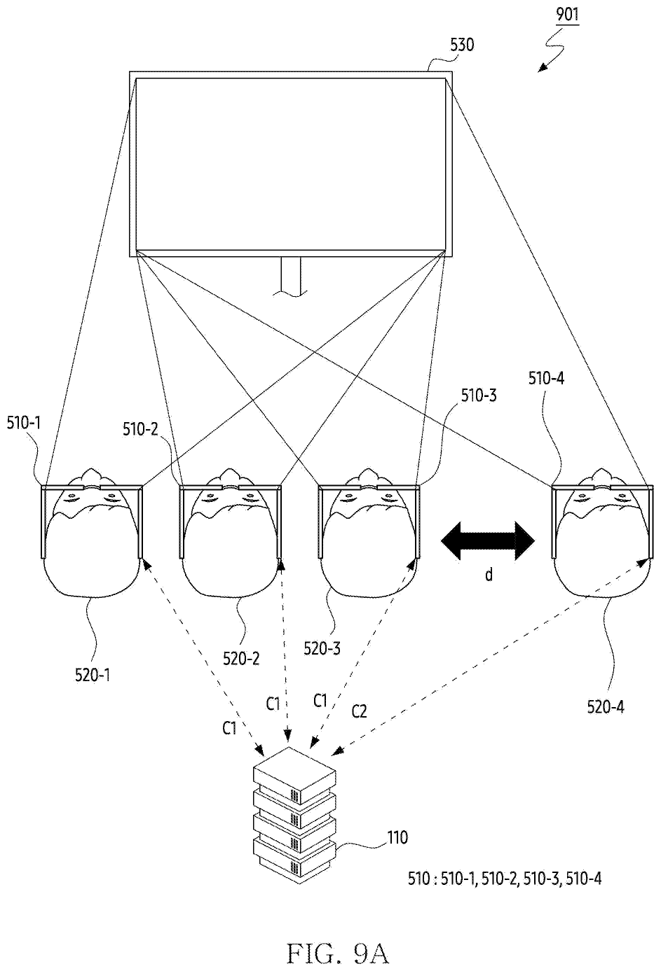

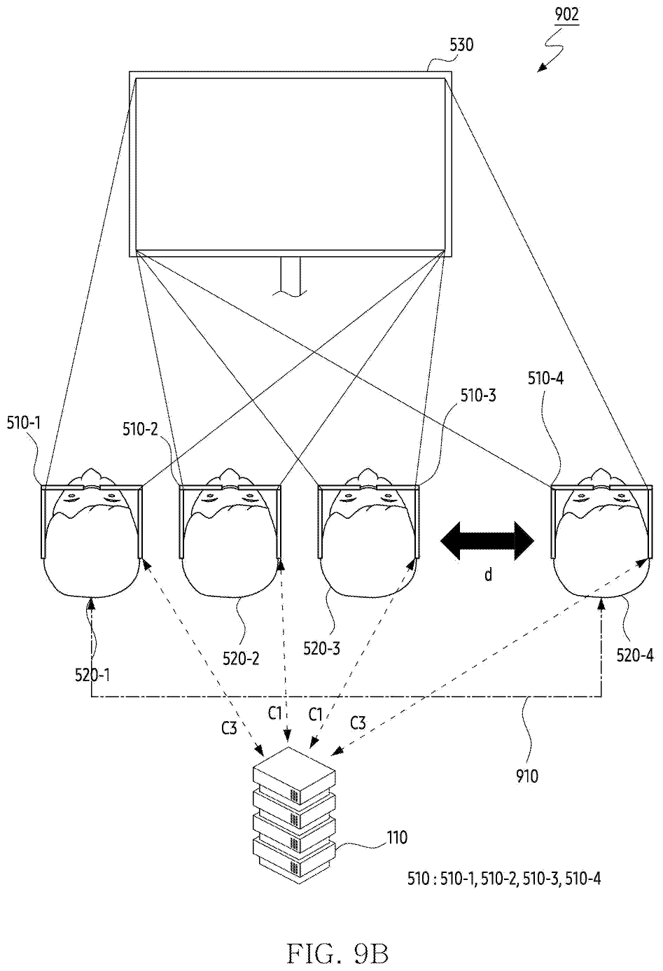

In an embodiment, based on the interaction between the external electronic devices (in an embodiment of FIG. 5, the wearable devices 510-1, 510-2, 510-3, and 510-4) that display the multimedia content through the external object 530, the server 110 may adaptively change the multimedia content displayed through each of the external objects. In an embodiment of FIG. 5, the server 110 may transmit information for displaying substantially the same multimedia content to wearable devices provided relatively close among the wearable devices 510-1, 510-2, 510-3, and 510-4. In an embodiment of FIG. 5, the server 110 may transmit information for displaying the same multimedia content to wearable devices to which a communication link associated with a phone call is established, such as a call connection, among the wearable devices 510-1, 510-2, 510-3, and 510-4. An example of an operation in which the server 110 changes the multimedia content displayed through at least one of the wearable devices 510-1, 510-2, 510-3, and 510-4 based on the interaction between the wearable devices 510-1, 510-2, 510-3, and 510-4, will be described with reference to FIGS. 9A and 9B.

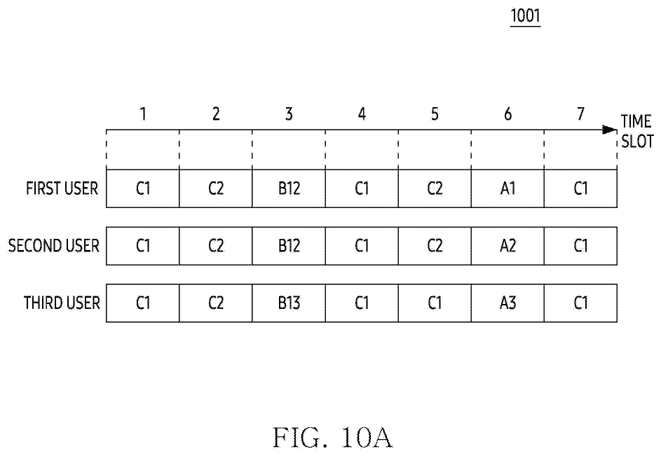

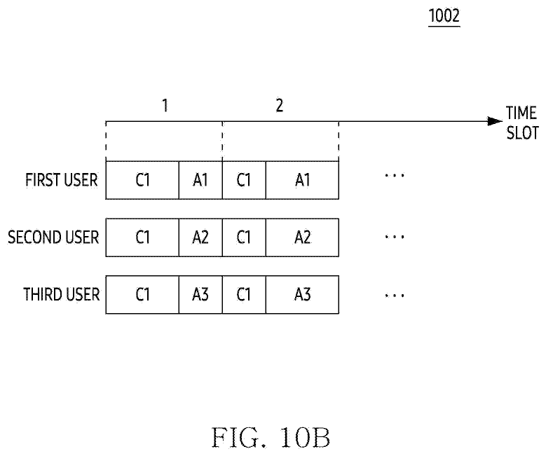

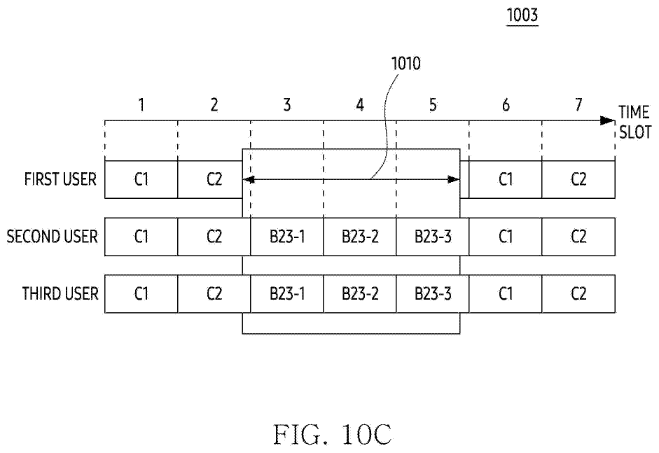

In an embodiment, the wearable device 510 that has received the information for displaying the multimedia content from the server 110 may display the multimedia content included in the information overlapping with the external object 530 in the FoV of the user 520. For example, the wearable device 510 may provide the user 520 with a scene which is the same with that the multimedia content is printed on one surface of the external object 530, by displaying the multimedia content having a matched shape on one surface of the external object 530. The wearable device 510 may activate any one cluster among a plurality of clusters corresponding to the wearable device 510 based on the interaction between the user 520 of the wearable device 510 and another user. The multimedia content displayed by the wearable device 510 may be changed based on one cluster activated by the wearable device 510 among the plurality of clusters. Among the clusters corresponding to the wearable device 510, as the one cluster activated by the wearable device 510 is changed, an example of an operation of changing the multimedia content displayed in the FoV of the user 520 by the wearable device 510 will be described with reference to FIGS. 10A, 10B, and 10C.

As described above, according to an embodiment, the wearable devices 510-1, 510-2, 510-3, and 510-4, and the server 110 may select the multimedia content to be displayed in association with the external object 530 commonly included in the FoVs of different users 520-1, 520-2, 520-3, and 520-4. The multimedia content may be selected, based on the interaction between the wearable devices 510-1, 510-2, 510-3, and 510-4, and/or on at least one cluster activated by the positions of the wearable devices 510-1, 510-2, 510-3, and 510-4, among the clusters including each of the wearable devices 510-1, 510-2, 510-3, and 510-4. Since the multimedia content displayed through the wearable devices 510-1, 510-2, 510-3, and 510-4 is adaptively adjusted based on the interaction between the wearable devices 510-1, 510-2, 510-3, and 510-4, the user experience of users 520-1, 520-2, 520-3, and 520-4 wearing the wearable devices 510-1, 510-2, 510-3, and 510-4 may be enhanced.

Hereinafter, with reference to FIG. 6, according to an embodiment, an example of one or more hardware included in the wearable device 510 and the server 110 and an application executed by each of the wearable device 510 and the server 110 will be described.

FIG. 6 is a block diagram of a wearable device 510 and a server 110 connected to the wearable device 510 according to an embodiment. The wearable device 510 and the server 110 of FIG. 6 may include the wearable device 510 and the server 110 of FIG. 5. Referring to FIG. 6, the wearable device 510 and the server 110 may be connected to each other based on a wired network and/or a wireless network. The wired network may include a network such as the Internet, a local area network (LAN), a wide area network (WAN), an Ethernet, or a combination thereof. The wireless network may include a network such as long term evolution (LTE), 5G new radio (NR), wireless fidelity (WiFi), Zigbee, near field communication (NFC), Bluetooth, bluetooth low-energy (BLE), or a combination thereof. Although the wearable device 510 and the server 110 are illustrated as being directly connected, the wearable device 510 and the server 110 may be indirectly connected through an intermediate node (e.g., an intermediate node 130 of FIG. 2) in the network.

In an embodiment, the wearable device 510 may include at least one of a processor 610, a memory 620, a display 630, a sensor 640, a communication circuit 650 or a camera 660. The processor 610, the memory 620, the display 630, the sensor 640, the communication circuit 650, and the camera 660 may be electronically and/or operably coupled with each other by an electronic component such as a communication bus 605. Hereinafter, that hardware is operably coupled with each other may mean that a direct connection or an indirect connection between hardware is established by wire or wirelessly so that the second hardware is controlled by the first hardware among the hardware. Although illustrated based on different blocks, the embodiment is not limited thereto, a portion (e.g., at least a portion of the processor 610, the memory 620, and the communication circuit 650) of the hardware of FIG. 6 may be included in a single integrated circuit, such as a system on a chip (SoC). The type and/or number of hardware included in the wearable device 510 is not limited as illustrated in FIG. 6. For example, the wearable device 510 may include only a portion of the hardware illustrated in FIG. 6.

In an embodiment, the processor 610 of the wearable device 510 may include hardware for processing data based on one or more instructions. The hardware for processing data may include, for example, an arithmetic and logic unit (ALU), a floating point unit (FPU), a field programmable gate array (FPGA), a central processing unit (CPU) and/or application processor (AP). The processor 610 may have a structure of single-core processor, or may have a structure of a multi-core processor such as a dual core, a quad core, or a hexa core.

According to an embodiment, the memory 620 of the wearable device 510 may include the hardware component for storing data and/or instructions inputted and/or output to the processor 610 of the wearable device 510. The memory 620 may include, for example, volatile memory such as random-access memory (RAM), and/or non-volatile memory such as read-only memory (ROM). The volatile memory may include, for example, at least one of dynamic RAM (DRAM), static RAM (SRAM), Cache RAM, and pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, solid state drive (SSD) and an embedded multi media card (eMMC).

In an embodiment, the display 630 of the wearable device 510 may output visualized information to a user (e.g., a user 520 of FIG. 5). For example, the display 630 may output the visualized information to the user, by being controlled by the processor 610 including a circuit such as a graphic processing unit (GPU). The display 630 may include a flat panel display (FPD) and/or electronic paper. The FPD may include a liquid crystal display (LCD), a plasma display panel (PDP), and/or one or more light emitting diodes (LEDs). The LED may include an organic LED (OLED). The display 630 of FIG. 6 may include at least one display 350 of FIGS. 3A, 3B, 4A, and/or 4B.

In an embodiment, the sensor 640 of the wearable device 510 may generates electrical information that may be processed by the processor 610 and/or the memory 620 of the wearable device 510 from non-electronic information associated with the wearable device 510. For example, the sensor 640 may include a global positioning system (GPS) sensor for detecting a geographic location of the wearable device 510. In addition to the GPS method, the sensor 640 may generate information indicating the geographic location of the wearable device 510 based on a global navigation satellite system (GNSS) such as galileo and beidou, or compass, for example. The information may be stored in the memory 620, may be processed by the processor 610, and/or may be transmitted to another electronic device (e.g., the server 110) different from the wearable device 510 through the communication circuit 650. The sensor 640 is not limited to those described above, and may include an image sensor for detecting electromagnetic waves including light, an illumination sensor and/or a time-of-flight (ToF) sensor, and an inertia measurement unit (IMU) for detecting physical motion of the wearable device 510.

In an embodiment, the communication circuit 650 of the wearable device 510 may include a hardware component for supporting transmission and/or reception of an electrical signal between the wearable device 510 and the server 110. Although only the server 110 is illustrated as an electronic device connected to the wearable device 510 through the communication circuit 650, the embodiment is not limited thereto. The communication circuit 650 may include, for example, at least one of a modem (MODEM), an antenna, and an optic/electronic (O/E) converter. The communication circuit 650 may support transmission and/or reception of the electrical signal based on various types of protocols, such as ethernet, local area network (LAN), wide area network (WAN), wireless fidelity (WiFi), Bluetooth, bluetooth low energy (BLE), ZigBee, long term evolution (LTE), and 5G new radio (NR).

In an embodiment, the camera 660 of the wearable device 510 may include one or more light sensors (e.g., a charged coupled device (CCD) sensor and a complementary metal oxide semiconductor (CMOS) sensor) that generate an electrical signal indicating the color and/or brightness of light. A plurality of light sensors included in the camera 660 may be provided in the form of a 2 dimensional array. The camera 660 may generate 2 dimensional frame data that corresponds to the light reaching the light sensors of the 2 dimensional array, by obtaining the electrical signal of each of the plurality of light sensors substantially simultaneously. For example, photo data captured using the camera 660 may mean one 2 dimensional frame data obtained from the camera 660. For example, video data captured using the camera 660 may mean a sequence of a plurality of 2 dimensional frame data obtained from the camera 660 according to a frame rate. The camera 660 is provided toward a direction in which the camera 660 receives light, and may further include a flash light for outputting light toward the direction. Although the camera 660 is illustrated based on a single block, the number of cameras 660 included in the wearable device 510 is not limited to the embodiment. Like one or more cameras 340 of FIGS. 3A to 3B and/or 4A to 4B, the wearable device 510 may include one or more cameras. In an embodiment, the camera 660 may be provided toward the FoV of the user, in a state in which the user wears the wearable device 510. The processor 610 may obtain frames including the scene of the FoV by controlling the camera 660 provided toward the FoV.

According to an embodiment, the wearable device 510 may include an output means for outputting information in a form other than a visualized form. For example, the wearable device 510 may include a speaker (e.g., speakers 392-1 and 392-2 of FIGS. 3A and 3B) for outputting an acoustic signal. For example, the wearable device 510 may include a motor for providing haptic feedback based on vibration.

In an embodiment of FIG. 6, the server 110 may include at least one of a processor 615, a memory 625, and a communication circuit 655. In the server 110, the processor 615, the memory 625, and the communication circuit 655 may be electrically and/or operatively coupled through the communication bus 606. The processor 615, the memory 625, and the communication circuit 655 included in the server 110 may include a hardware component and/or a circuit corresponding to the processor 610, the memory 620, and the communication circuit 650 of the wearable device 510. Hereinafter, in order to reduce repetition, a description of the processor 615, the memory 625, and the communication circuit 655 included in the server 110 may be omitted to the extent features of these components overlap the processor 610, the memory 620, and the communication circuit 650 in the wearable device 510.

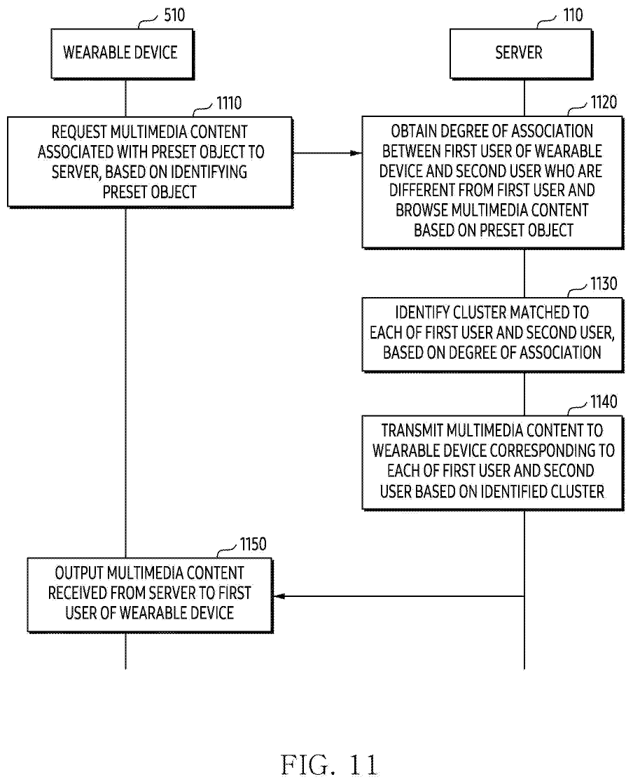

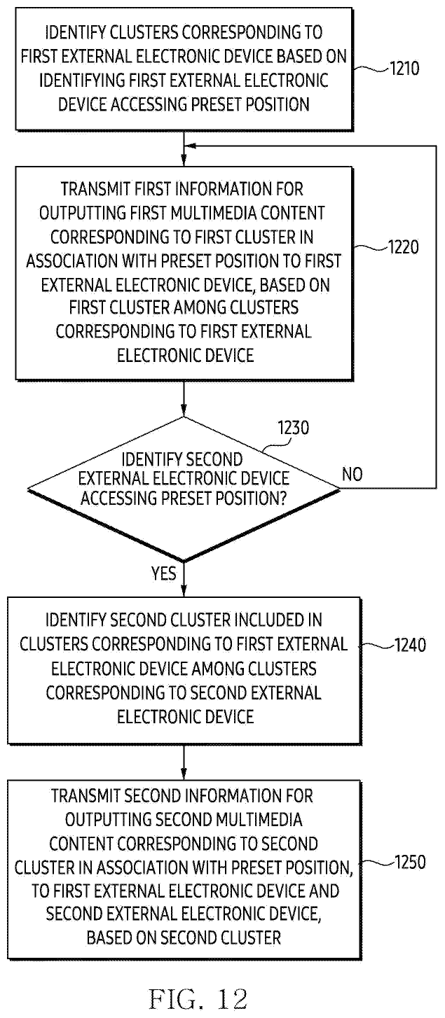

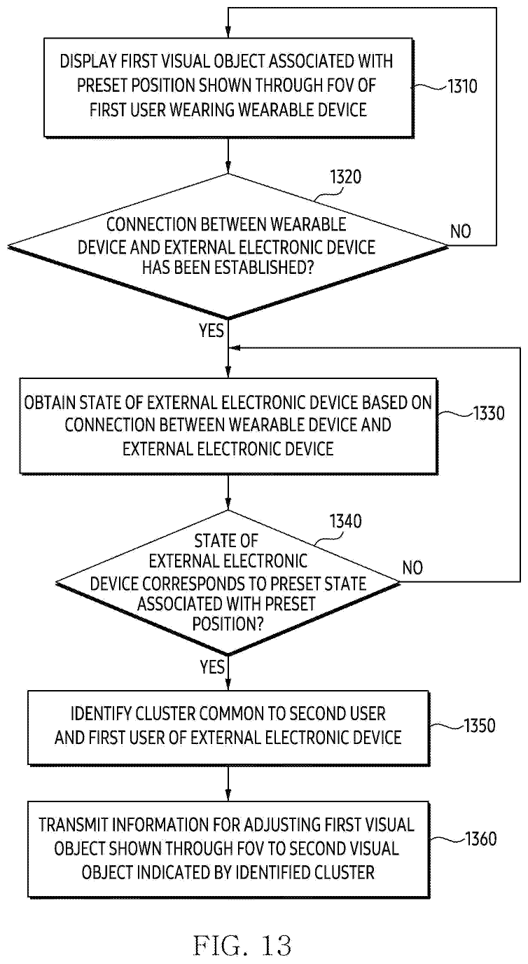

In an embodiment, in the memory 620 of the wearable device 510, one or more instructions (or commands) indicating a calculation and/or operation to be performed on data by the processor 610 of the wearable device 510 may be stored. A set of one or more instructions may be referred to as firmware, operating system, process, routine, sub-routine, and/or application. In the memory 625 of the server 110, the one or more instructions indicating the calculation and/or operation to be performed on the data by the processor 615 of the server 110 may be stored. Referring to FIG. 6, the processor 610 of the wearable device 510 may perform at least one of the operations of FIG. 11 and/or FIG. 13, by executing the multimedia content output application 670 in the memory 620. Referring to FIG. 6, the processor 615 of the server 110 may perform at least one of the operations of FIG. 11 to FIG. 12, by executing the multimedia content providing application 680 in the memory 625. Hereinafter, that an application is installed in an electronic device (e.g., the wearable device 510 and/or the server 110) means that the one or more instructions provided in the form of an application are stored in the memory of the electronic device, and the one or more applications are stored in a format (e.g., a file having an extension preset by an operating system of the electronic device) executable by a processor of the electronic device.

Referring to FIG. 6, the one or more instructions included in the multimedia content output application 670 may be divided into a user information collector 671, multimedia content requester 672, multimedia content manager 673, and/or multimedia content output device 674. The multimedia content output application 670 may be connected to the wearable device 510 through the communication circuit 650 and provided through another server different from the server 110. According to an embodiment, the another server may be associated with a third-party application store. In a state in which the multimedia content output application 670 is executed, the processor 610 of the wearable device 510 may monitor interactions between users wearing the wearable device 510 and another user. In the above state, the processor 610 of the wearable device 510 may request multimedia content corresponding to the wearable device 510 from the server 110. The processor 610 of the wearable device 510 may output the multimedia content in the FoV of the user wearing the wearable device 510, by controlling the display 630, based on the multimedia content received from the server 110. In a state in which the multimedia content providing application 680 is executed, based on the request from the wearable device 510, the processor 615 of the server 110 may transmit multimedia content corresponding to any one cluster among clusters corresponding to the wearable device 510 and/or the user wearing the wearable device 510 to the wearable device 510. In the above state, the server 110 may change a method (e.g., an order and/or a rate at which a plurality of multimedia contents are displayed) to output the multimedia content through the wearable device 510.

In an embodiment, the processor 610 of the wearable device 510 may obtain information required to select multimedia content that matches the user (e.g., a user 520 of FIG. 5) wearing the wearable device 510 based on the execution of the user information collector 671. The information may include a history (e.g., payment history) of browsing or purchasing one or more products through the wearable device 510 by the user. The information may include a history in which the user inputs a keyword to a search service through the wearable device 510. The information may include a history of clicking a link in a web page displayed in the display 630 of the wearable device 510 by the user, and/or an address (e.g., a uniform resource locator (URL)) of the link. The processor 610 of the wearable device 510 may register the wearable device 510 and/or the user in the server 110 based on the execution of the user information collector 671. The processor 610 of the wearable device 510 may transmit the information together with the registered identifier (e.g., ID) of the user based on the execution of the user information collector 671.

In an embodiment, the processor 610 of the wearable device 510 may request multimedia content to be displayed through the wearable device 510 from the server 110 based on the execution of the multimedia content requester 672. Based on the execution of the multimedia content requester 672, the wearable device 510 may transmit information required for display of the multimedia content to the server 110. The information may include at least one of an identifier of the user wearing the wearable device 510 or an identifier of an external object (e.g., an external object 530 of FIG. 5) in which the multimedia content will be displayed. The wearable device 510 may receive, in response to the information, one or more multimedia contents and information indicating a method of displaying the one or more multimedia contents from the server 110 through the communication circuit 650.

In an embodiment, the processor 610 of the wearable device 510 may determine whether to display the one or more multimedia contents received from the server 110 based on the multimedia content manager 673. Based on the execution of the multimedia content manager 673, the processor 610 of the wearable device 510 may adjust activation and/or inactivation of a plurality of clusters assigned to the user. For example, based on whether the external object on which the multimedia content is to be displayed is seen by the user wearing the wearable device 510, the wearable device 510 may display the one or more multimedia contents in the display 630. The wearable device 510 may identify whether an external object for displaying the multimedia content is included in the FoV of the user, based on the position of the user, movement direction, and/or speed, identified based on data of the sensor 640. The processor 610 of the wearable device 510 may predict a timing at which the user will view the external object based on the data of the sensor 640. Based on the execution of the multimedia content manager 673, the processor 610 of the wearable device 510 may output the one or more multimedia contents received from the server 110 by controlling the execution of the multimedia content output device 674.

In an embodiment, the processor 610 of the wearable device 510 may output the multimedia content included in the information received from the server 110 based on the execution of the multimedia content output device 674. The wearable device 510 may output the one or more multimedia contents based on a method included in the information. The method may include a method of sequentially displaying the plurality of multimedia contents based on a time interval (e.g., a time slot). The method may include a layout and/or a ratio of sizes in which a plurality of multimedia contents will be displayed simultaneously on an external object corresponding to the multimedia content. The order and/or method in which different multimedia contents of FIGS. 9A, 9B, 10A, 10B and 10C are output may be associated with the method included in the information received from the server 110.

In an embodiment, the processor 610 of the wearable device 510 may adjust whether to output at least one multimedia content based on execution of the multimedia content output device 674. For example, based on whether an external object linked with the multimedia content is displayed in the FoV of the user wearing the wearable device 510, the processor 610 of the wearable device 510 may display the multimedia content in the display 630. Based on identifying that the external object is included in the FoV, the processor 610 of the wearable device 510 may display the multimedia content in association with the external object.

Referring to FIG. 6, one or more instructions included in the multimedia content providing application 680 may be divided into a user information manager 681, a cluster manager 682, a multimedia content scheduler 683, and/or a multimedia content transmitter 684. In a state in which the multimedia content providing application 680 is executed, the processor 615 of the server 110 may transmit information for displaying the at least one multimedia content to external electronic devices including the wearable device 510 connected to the server 110. In the above state, the processor 615 of the server 110 may receive information to identify a cluster corresponding to each of the external electronic devices from the external electronic devices through the communication circuit 655. Based on the cluster identified by the information, the server 110 may transmit information for displaying the multimedia content to the external electronic devices. The information may include information for reproducing the multimedia content, and/or information indicating a method in which the multimedia content is displayed through the external electronic device.

In an embodiment, the processor 615 of the server 110 may manage information for selecting the at least one multimedia content that matches users of external electronic devices (e.g., wearable devices 510) connected to the server 110 based on the execution of the user information manager 681. The information collected by the wearable device 510 based on the execution of the user information collector 671 may be collected by the server 110 where the user information manager 681 is executed. The server 110 may store the information collected from external electronic devices in user information 692 in the memory 625. The user information 692 may include preferences for multimedia content 694 of users of the external electronic devices connected to the server 110. The user information 692 may be referred to as account information, profile information, and/or preference information for the user. The user information 692 may include the payment history of the users. Based on the execution of the user information manager 681, the processor 615 of the server 110 may predict a product to be purchased by the users. The result of predicting the product may be stored in the user information 692.

In an embodiment, the processor 615 of the server 110 may obtain a parameter indicating the interaction between the users of the external electronic devices connected to the server 110 based on the execution of the cluster manager 682. The parameter may be referred to as a virtual distance in that it is different from a physical distance between the users. The parameter may be referred to as a degree of association between the users. The processor 615 of the server 110 may calculate virtual distances between the users and may group the users based on the virtual distances. Grouping the users may include an operation in which the processor 615 of the server 110 identifies at least one cluster corresponding to each of the users. The processor 615 of the server 110 may create, update, or delete at least one cluster to be matched to the users. In a state in which the cluster manager 682 is executed, the processor 615 of the server 110 may calculate the virtual distances between the users based on the user information 692. In the above state, the processor 615 of the server 110 may identify a cluster including the grouped users by grouping users spaced apart from by a virtual distance less than or equal to the threshold. For example, the processor 615 of the server 110 may add IDs of one or more users classified as clusters in the cluster. In the above state, the processor 615 of the server 110 may match the at least one multimedia content corresponding to the identified cluster. For example, the 615 610 of the server 110 may obtain a list of the one or more multimedia contents corresponding to the cluster.

In an embodiment, based on the execution of the cluster manager 682, the processor 615 of the server 110 may calculate the virtual distance d_{ab} between user a and user b as shown in Equation 1.

d_{ab}=f(P_{ab},r_{ab}⁻¹,g_{ab}⁻¹) (Equation 1)

The Equation 1 is only an example to help understanding, it is not limited thereto, and may be modified, applied, or expanded in various methods.

In an embodiment, referring to the Equation 1, the virtual distance d_{ab} may be proportional to the physical distance p_{ab} between the user a and the user b. The physical distance p_{ab} between the user a and the user b may be identified by GPS sensors of the external electronic devices corresponding to the user a and the user b. Referring to the Equation 1, the virtual distance d_{ab} may be inversely proportional to a parameter r_{ab} indicating an interaction between the user a and the user b. The parameter r_{ab} indicating the interaction between the user a and the user b may be associated with at least one of a relationship (e.g., whether users a and b follow each other) in a social network service between the user a and the user b, whether to share contact information of the user a and the user b, a history of interactions (e.g., phone calls, and/or exchanges of messages) between the user a and the user b, the user a and the user b's language, and/or nationality. For example, information about whether users a and b follow each other may be included in a follow list. For example, the parameter r_{ab} may be proportional to the history and/or frequency in which interactions between the user a and the user b have occurred. Referring to the Equation 1, the virtual distance d_{ab} may be inversely proportional to a parameter g_{ab} indicating a common behavior between the user a and the user b. The parameter g_{ab} may be proportional to the similarity of the community to which the user a and the user b are subscribed, whether the user a and the user b are currently interacting, and/or the activity history performed together by the user a and the user b.

In an embodiment, referring to the Equation 1, the virtual distance d_{ab} between the user a and the user b may be proportional to the physical distance p_{ab} between the user a and the user b and may be inversely proportional to the parameters r_{ab} and g_{ab}. The parameters r_{ab} and g_{ab} may be increased or decreased by interaction between the user a and the user b. For example, the parameters r_{ab} and g_{ab} may increase as the frequency of contact by the user a and the user b increases. For example, in case that the user a and the user b add each other in a preset list (e.g., a black list, and/or a white list), the parameters r_{ab} and g_{ab} may remain at a specified value independently of the interaction between the user a and the user b, or may have a relatively low proportional constant. Based on the proportional constant, the degree to which the parameters r_{ab} and g_{ab} are changed with respect to the frequency of contact between the user a and the user b may be reduced.

In an embodiment, the processor 615 of the server 110 may determine a method in which the multimedia content 694 will be displayed through each of the external electronic devices connected to the server 110, based on the execution of the multimedia content scheduler 683. In a state in which the multimedia content scheduler 683 is executed, the processor 615 of the server 110 may select a method in which one or more multimedia contents included in the list will be displayed through the external electronic device, based on the list of the multimedia content corresponding to the cluster including the user of the external electronic device. The list may be obtained based on execution of the cluster manager 682. The method may be associated with the form, time, and/or size in which the multimedia content will be displayed. The method may be adjusted by a provider of the multimedia content (e.g., an advertiser in the case of the multimedia content including advertisements).

In an embodiment, the processor 615 of the server 110 may transmit information for displaying the one or more multimedia contents to at least one external electronic device connected to the server 110 based on the method determined by the multimedia content scheduler 683 based on the execution of the multimedia content transmitter 684. In a state in which the multimedia content transmitter 684 is executed, in response to a request for the multimedia content from the external electronic device, the processor 615 of the server 110 may transmit information for displaying at least one multimedia content matched to a cluster associated with the user of the external electronic device to the external electronic device. Based on receiving the above request, the processor 615 of the server 110 may identify a cluster matching the user corresponding to the request, by executing the cluster manager 682. The processor 615 of the server 110 may identify one or more multimedia contents to be displayed through the external electronic device corresponding to the request, by executing the multimedia content scheduler 683, based on the identified cluster. The processor 615 of the server 110 may transmit information for caching a plurality of multimedia contents to be displayed through the wearable device 510, to the wearable device 510, based on the execution of the multimedia content transmitter 684. After the multimedia content is cached by the wearable device 510, the server 110 may transmit information (e.g., a flag) indicating which multimedia content to reproduce among cached multimedia contents, to the wearable device 510, based on the execution of the multimedia content transmitter 684. Based on the information, the server 110 may control selective output of the multimedia contents by the wearable device 510.

As described above, according to an embodiment, the server 110 and the wearable device 510 may change the multimedia content to be displayed through the display 630 of the wearable device 510 based on the interaction between the user of the wearable device 510 and other users connected to the server 110. For example, the multimedia content displayed through the display 630 of the wearable device 510 may be changed based on whether the interaction between the user and the other users occurs. In case of displaying the multimedia content 694 such as the advertisement, as the wearable device 510 outputs the advertisement being displayed to the other users to the user interacting with the other user based on the phone call, the user and the other user may browse the same advertisement. Since the user and the other user browse the same advertisement, the possibility that the user and the other user recognize the advertisement or interact based on the advertisement may increase.

In an embodiment, an example in which the multimedia content is displayed based on an external object (e.g., the external object 530 of FIG. 5) such as a landmark has been described, but the embodiment is not limited thereto. Hereinafter, with reference to FIG. 7, an example of an object included in a virtual space formed by the server 110 and displaying the multimedia content will be described.

FIG. 7 illustrates an example of an operation in which a wearable device 510 displays multimedia content based on a virtual space 710 according to an embodiment. The wearable device 510 and a server 110 of FIGS. 5 and 6 may include the wearable device 510 and the server 110 of FIG. 7.

Referring to FIG. 7, the virtual space 710 formed by the server 110 is exemplarily illustrated. In the virtual space 710, the server 110 may provide or render an avatar and/or a virtual object 730 based on a three-dimensional coordinate system. The virtual space 710 may be formed for a metaverse service provided by the server 110. In the virtual space 710, the server 110 may provide the virtual object 730 for displaying the multimedia content. The virtual object 730 may include an object (e.g., a building) provided in the virtual space 710 or an object (e.g., a costume of the avatar) movable in the virtual space 710. The virtual object 730 may include a portion of a terrain formed in the virtual space 710.

As the wearable device 510 accesses the server 110, the server 110 may transmit information for displaying at least a portion of the virtual space 710 to the wearable device 510. Based on the user information of the user 520 of the wearable device 510, the server 110 may render (or output) a first avatar 720-1 corresponding to the user 520 in the virtual space 710. The server 110 may move the first avatar 720-1 in the virtual space 710 based on the motion of the user 520 measured by the wearable device 510. The server 110 may transmit information for displaying a portion of the virtual space 710 shown by the first avatar 720-1 to the wearable device 510. Referring to FIG. 7, an example of a screen 740 that the wearable device 510 displays in the FoV of the user 520 is illustrated, based on the information received from the server 110. The wearable device 510 may provide a user experience such that the user 520 browses the virtual space 710 based on the first avatar 720-1, by adjusting the display of the screen 740 according to the motion of the head of the user 520 wearing the wearable device 510.

In an embodiment, the server 110 may identify at least one cluster corresponding to the user 520 wearing the wearable device 510, based on identifying the virtual object 730 for displaying the multimedia content and/or a position corresponding to the virtual object 730 is included, in the screen 740 displayed by the wearable device 510. The server 110 may determine whether to display the multimedia content in association with the virtual object 730, based on the distance and/or angle between the first avatar 720-1 and the virtual object 730 corresponding to the user 520 in the virtual space 710. For example, in a case in which the first avatar 720-1 approaches toward the virtual object 730, and is within a distance less than a reference distance, the server 110 may decide to display the multimedia content in association with the virtual object 730. The reference distance may be a present distance (e.g., about 10 m). However, the disclosure is not limited to a distance of 10 m, and as such, according to an embodiment, the reference distance may be different than 10 m. For example, the server 110 may determine whether to display the multimedia content in association with the virtual object 730 based on whether another object exists between the first avatar 720-1 and the virtual object 730 in the virtual space 710. For example, based on whether the virtual object 730 is covered by the other object displayed in the screen 740, the server 110 may determine whether to display the multimedia content in association with the virtual object 730. For example, based on the switching of application displayed on the screen 740, the server 110 may determine whether to display the multimedia content in association with the virtual object 730. The server 110 may identify multimedia content to be displayed in association with the virtual object 730 included in the screen 740 based on the execution of the multimedia content providing application 680 of FIG. 6.

Referring to FIG. 7, in the screen 740, an exemplary case in which the wearable device 510 outputs and/or projects the multimedia content in association with the virtual object 730 in the virtual space 710 is illustrated. The multimedia content may be included in information received from the server 110. The wearable device 510 may output the multimedia content by adjusting the texture of the virtual object 730 included in the screen 740. The wearable device 510 may output the multimedia content by displaying a visual object 760 adjacent to the virtual object 730 included in the screen 740. In an exemplary case of outputting multimedia content associated with an advertisement (e.g., oral advertisement) through the screen 740, the wearable device 510 may display the advertisement to the user 520 by using the virtual object 730 and the visual object 760 associated with the virtual object 730. The wearable device 510 may display a web page associated with the multimedia content in screen 740 or may output a result of executing an application associated with the multimedia content, based on the input indicating that the virtual object 730, and/or the visual object 760 is selected. The wearable device 510 may download the web page associated with the multimedia content from the server 110, by communicating with the server 110 based on the input.

Referring to FIG. 7, in the screen 740, a selectable visual object 750 may be output. For example, the wearable device 510 may select the selectable visual object 750 for adjusting the multimedia content to be displayed in association with the virtual object 730 based on another electronic device accessing the virtual object 730. For example, the selectable visual object 750 may be a notification (“ACTIVATE ADVERTISEMENT: ON”) as illustrated in FIG. 7. In response to an input indicating selection of the selectable visual object 750, the wearable device 510 may transmit to the server 110, a signal for requesting multimedia content to be displayed in association with the virtual object 730 based on at least one cluster in which the user 520 is classified. Based on the selectable visual object 750, the multimedia content displayed through the screen 740 of the wearable device 510 may be synchronized with at least one electronic device different from the wearable device 510. In response to the input indicating the selection of the selectable visual object 750, the wearable device 510 may enter a mode for synchronizing the multimedia content displayed through the screen 740 with another electronic device.

According to an embodiment, the server 110 connected to the wearable device 510 may adjust multimedia content to be displayed in association with the virtual object 730 in each of the external electronic devices, based on the interaction between external electronic devices that commonly display the virtual object 730 in the virtual space 710. Referring to FIG. 7, in the virtual space 710, the first avatar 720-1 corresponding to the user 520 of the wearable device 510 and a second avatar 720-2 corresponding to another user different from the user 520 may be provided toward the virtual object 730. The server 110 may calculate a virtual distance between users (e.g., the user 520 and the other user) of the external electronic devices, based on identifying two external electronic devices (e.g., the wearable device 510 corresponding to the first avatar 720-1 and the external electronic device corresponding to the second avatar 720-2) accessing a preset position in the virtual space 710 in which the virtual object 730 is provided. Based on the virtual distance, the server 110 may select multimedia content to be transmitted to the external electronic devices corresponding to the users.

For example, in case that the virtual distance between the user 520 and the other user corresponding to the second avatar 720-2 exceeds the threshold distance for grouping into a single cluster, the server 110 may classify the user 520 and the other user into different clusters. In the above example, the server 110 may transmit information for displaying the first multimedia content corresponding to the first cluster to the wearable device 510 corresponding to the user 520 and may transmit information for displaying the second multimedia content corresponding to the second cluster to the external electronic device corresponding to the other user. In the above example, in case that an interaction (e.g., call connection) occurs between the user 520 and the other user, as the virtual distance of Equation 1 is reduced to less than the threshold distance, the server 110 may classify the user 520 and the other user into the single cluster. Based on classifying users 520 and the other user into the single cluster, the server 110 may transmit information for commonly displaying multimedia content corresponding to the single cluster to the wearable device 510 and all external electronic devices.

For example, in case that the virtual distance between the user 520 and the other user corresponding to the second avatar 720-2 is less than the threshold distance, the server 110 may classify the user 520 and the other user into the single cluster. For example, in case that a product purchased in common by the user 520 and the other user exists, or a community subscribed in common exists, the virtual distance may be reduced to less than the threshold distance based on the Equation 1. In the above example, the server 110 may transmit information for displaying specific multimedia content to the wearable device 510 corresponding to the user 520 and to all of the external electronic devices corresponding to the other user. In the above example, the virtual object 730 and/or the visual object 760 in the screen 740 may be displayed to the other user through the display of the external electronic device.

As described above, according to an embodiment, the wearable device 510 may display at least a portion of the virtual space 710 including the virtual object 730 for outputting multimedia content in a state of accessing the virtual space 710 formed by the server 110. The server 110 may classify a plurality of electronic devices accessing the virtual object 730 based on one or more clusters. With a plurality of electronic devices classified as the single cluster, the server 110 may transmit information for synchronizing and displaying substantially matched multimedia content. Based on the information, the plurality of electronic devices browsing the virtual object 730 may provide a substantially matched user experience based on the multimedia content.

Hereinafter, an example of an operation of selecting multimedia content to be transmitted to a plurality of electronic devices accessed to the virtual space 710 by the server 110 according to an embodiment will be described with reference to FIG. 8.

FIG. 8 illustrates an example of an operation of selecting multimedia content to be provided to the users based on a relationship between users corresponding to wearable devices, according to an embodiment. Referring to FIG. 8, an example of an operation performed by a server 110 of FIG. 5 to FIG. 7 to select multimedia content to be transmitted to the wearable devices (e.g., the wearable device 510 of FIG. 5 to FIG. 7) connected to the server 110 is described.

Referring to FIG. 8, a diagram 800 that classifies the multimedia content (e.g., advertisement) suitable for the first user, the second user and the third user is illustrated, based on clusters classified by the first user, the second user and the third user. Multimedia content A, multimedia content B, and multimedia content C may be multimedia content suitable only for each of the first user, the second user and the third user. The meaning that a specific multimedia content is suitable for a specific user may mean that the specific multimedia content is included in at least one of the clusters corresponding to the specific user. The meaning that the specific multimedia content is not suitable for the specific user may mean that the specific multimedia content is not included in the entire clusters corresponding to the specific user. For example, the multimedia content A may be included in at least one of the clusters of the first user, but may not be included in any of the clusters of the second user and the third user. AB multimedia content may be multimedia content suitable for the first user and the second user, but not suitable for the third user. AC multimedia content may be multimedia content suitable for the first user and the third user, but not suitable for the second user. For example, the AC multimedia content may be associated with a product commonly purchased by the first user and the third user. BC multimedia content may be multimedia content suitable for the second user and the third user, but not suitable for the first user. ABC multimedia content may be multimedia content suitable for all the first user, the second user and the third user. D multimedia content may be multimedia content set not to target a specific user or multimedia content set to be output based on a specific condition.

According to an embodiment, the server (e.g., the server 110 of FIGS. 5 to 7) may transmit multimedia content selected based on the diagram 800 to electronic devices of the first user, the second user and the third user. In response to identifying the electronic devices of the first user and the second user accessing the object (e.g., an external object 530 of FIG. 5, and/or a virtual object 730 of FIG. 7) for displaying the multimedia content, the server may transmit information for displaying the AB multimedia content suitable for both the first user and the second user to the electronic devices. In a state of transmitting the ABC multimedia content suitable for both first and third users to electronic devices of the first user, the second user and the third user, in response to identifying interaction between the second user and the third user, the server may transmit the BC multimedia content suitable for the second user and the third user to the electronic devices of the second user and the third user. While transmitting the BC multimedia content to the electronic devices of the second user and the third user, the server may transmit information for displaying the ABC multimedia content and/or the multimedia content to the electronic device of the first user.

In an embodiment, in case that there are a plurality of multimedia contents suitable for the specific user, the server may adjust the priority among the plurality of multimedia contents. For example, in case that Z multimedia content suitable for all of the first user, the second user and the third user is identified together with the ABC multimedia content, the server may determine a priority between the ABC multimedia content and the Z multimedia content. The priority may be associated with the number of users who prefer each of the multimedia contents. For example, the priority of multimedia content preferred by relatively many users among the ABC multimedia content and the Z multimedia content may be higher than that of other multimedia content. The priority may be associated with an order of displaying the multimedia content.

Hereinafter, an example of an operation in which the wearable devices display different multimedia contents based on an interaction between users of the wearable devices according to an embodiment will be described with reference to FIGS. 9A and 9B.

FIGS. 9A and 9B illustrate an example of an operation in which wearable devices 510-1, 510-2, 510-3, and 510-4 display multimedia content based on a relationship between users corresponding to the wearable devices 510-1, 510-2, 510-3, and 510-4, according to an embodiment. A wearable device 510 including the wearable devices 510-1, 510-2, 510-3, and 510-4 of FIGS. 9A and 9B may be an example of the wearable device 510 of FIGS. 5 to 7. A server 110 of FIGS. 5 to 7 may include the wearable device 510 of FIGS. 9A and 9B.

Referring to FIG. 9A, a first state 901 in which the wearable devices 510-1, 510-2, 510-3, and 510-4 are provided toward an external object 530 is exemplarily illustrated. The server 110 may identify the external object 530 commonly included in FoVs of the wearable devices 510-1, 510-2, 510-3, and 510-4. In case that the external object 530 is an object set by the server 110 for selective display of multimedia content, a server 110 may identify virtual distances between users 520-1, 520-2, 520-3, and 520-4 of each of the wearable devices 510-1, 510-2, 510-3, and 510-4, and/or one or more clusters in which users 520-1, 520-2, 520-3, and 520-4 are classified. Although the operation of the wearable device 510 and the server 110 based on the external object 530, which is a real object such as a building, is described, the embodiment is not limited thereto, and the wearable device 510 and the server 110 may operate similarly for the virtual object 730 of FIG. 7.

Referring to FIG. 9A, in the first state 901 of identifying that the fourth wearable device 510-4 is spaced apart by a distance d from the wearable devices 510-1, 510-2, and 510-3, among the virtual distance between the users 520-1, 520-2, 520-3, and 520-4 obtained by the server 110, based on Equation 1, the virtual distance between the fourth user 520-4 and other users 520-1, 520-2, and 520-3 may be calculated to be greater than other virtual distance. For example, the server 110 may classify the fourth user 520-4 into a cluster different from other users 520-1, 520-2, and 520-3. The server 110 may transmit information for displaying multimedia content C1 corresponding to the same cluster, to the wearable devices 510-1, 510-2, and 510-3 corresponding to the other users 520-1, 520-2, and 520-3. The server 110 may transmit information for displaying multimedia content C2 corresponding to another cluster different from the cluster into which the other users 520-1, 520-2, and 520-3 are classified, to the fourth wearable device 510-4 corresponding to the fourth user 520-4.

In the state 901 of FIG. 9A, the server 110 may identify changes in virtual distances between the users 520-1, 520-2, 520-3, and 520-4. For example, in case that a call connection is established between the first user 520-1 and the fourth user 520-4, the first wearable device 510-1 of the first user 520-1 and/or the fourth wearable device 510-4 of the fourth user 520-4 may transmit a signal for notifying of the occurrence of an interaction between the first user 520-1 and the fourth user 520-4 based on the call connection, to the server 110. The server 110 may reduce the virtual distance between the first user 520-1 and the fourth user 520-4 based on receiving the signal. As the virtual distance decreases, the first user 520-1 and the fourth user 520-4 may be classified into the same cluster. For example, the server 110 may create a cluster for exclusively classifying the first user 520-1 and the fourth user 520-4 based on the decrease in the virtual distance.

A state 902 of FIG. 9B illustrates an exemplary state in which the server 110 transmits multimedia content to the wearable devices 510-1, 510-2, 510-3, and 510-4, based on the reduced virtual distance between the first user 520-1 and the fourth user 520-4. While the call connection 910 between the first user 520-1 and the fourth user 520-4, may transmit information for displaying multimedia content C3 corresponding to a cluster including both the first user 520-1 and the fourth user 520-4, to the first wearable device 510-1 corresponding to the first user 520-1 and a fourth wearable device 510-4 corresponding to the fourth user 520-4. The multimedia content C3 may correspond to a cluster identified by an interaction history between the first user 520-1 and the fourth user 520-4. The server 110 may maintain transmitting information transmitted in the state 901, to other users 520-2 and 520-3 different from the first user 520-1 and the fourth user 520-4. In a state 902, the first user 520-1 and the fourth user 520-4 interacting based on the call connection 910 may access the multimedia content C3 displayed in association with the external object 530 through the wearable devices 510-1 and 510-4.

In an embodiment, in case that the call connection 910 is released, since the virtual distance between the first user 520-1 and the fourth user 520-4 increases again, the state in which multimedia content is displayed in association with the external object 530 through the wearable devices 510-1, 510-2, 510-3, and 510-4 may be restored from the state 902 to the state 901.

As described above, in the state of displaying the multimedia content associated with the external object 530 shown through the FoV of the first user 520-1 wearing the first wearable device 510-1, the first wearable device 510-1 may identify the interaction between the first user 520-1 and another user (e.g., the fourth user 520-4). Based on the interaction, the first wearable device 510-1 may adjust the multimedia content associated with the external object 530 based on a cluster common to the first user 520-1 and the other user. The adjusted multimedia content may be displayed substantially simultaneously on another electronic device (e.g., the fourth wearable device 510-4) of the other user.

Hereinafter, with reference to FIGS. 10A, 10B and 10C, an example of an operation of controlling timing at which the server 110 connected to a plurality of electronic devices displays the multimedia contents through the plurality of electronic devices will be described.

FIGS. 10A, 10B, and 10C illustrate an example of a timing diagram indicating an order in which wearable devices output multimedia content according to an embodiment. Referring to FIGS. 10A, 10B, and 10C, multimedia contents displayed through the wearable devices of the first user, the second user and the third user are illustrated along a time axis. The wearable devices may be an example of a wearable device 510 of FIGS. 5 to 7. For example, the wearable devices may receive information for displaying the multimedia content from the server 110 of FIGS. 5 to 7.

Referring to FIGS. 10A, 10B, and 10C, the order of multimedia content displayed by wearable devices corresponding to the first user, the second user and the third user is exemplarily illustrated based on seven time slots formed on the time axis. In case that the multimedia content includes an advertisement, the time slot may have a preset period (e.g., 15 seconds, 30 seconds, and/or 1 minute) associated with the advertisement. It is assumed that the first user, the second user and the third user are browsing one object for displaying multimedia content through wearable devices, such as an external object 530 of FIG. 5 and/or a virtual object 730 of FIG. 7. A server connected to the wearable devices (e.g., a server 110 of FIGS. 5 to 7) may schedule one or more multimedia contents to be displayed to each of the first user, the second user and the third user based on one or more clusters corresponding to the first user, the second user and the third user. The text described in each of the time slots of FIGS. 10A, 10B, and 10C may be an exemplary name of multimedia content displayed in the corresponding time slot.

In an exemplary state 1001 illustrated in FIG. 10A, the wearable device of the first user may display multimedia content in the order of C1, C2, B12, C1, C2, A1, and C1 along different time slots. Meanwhile, the wearable device of the third user may display the multimedia content in the order of C1, C2, B13, C1, C2, A3, and C1 in each of the time slots. For example, the multimedia content C1 may be multimedia content having the highest preference for all of the first user to the third user, among the multimedia contents C1 and C2 corresponding to the cluster including all of the first user, the second user and the third user. In the third time slot after displaying the multimedia contents C1 and C2, the wearable devices corresponding to the first user and the second user may display the multimedia content B12 preferred by the first user and the second user, and the wearable device corresponding to the third user may display the multimedia content B13 preferred by the third user. The multimedia content B12 may be multimedia content not preferred by the third user. Referring to the state 1001 of FIG. 10A, the server connected to the wearable devices of the first user, the second user and the third user may adjust the order of multimedia content to be transmitted to each of the wearable devices based on the time slots based on the cluster including the first user, the second user and the third user and the preference of the first user, the second user and the third user.

In an exemplary state 1002 of FIG. 10B, the server connected to the wearable devices, together with the time slot, may adjust the method in which the multimedia content is displayed, based on the size between the multimedia contents. In the first time slot, the wearable devices of the first user, the second user and the third user may commonly display the multimedia content C1 corresponding to a cluster including both the first user, the second user and the third user. Together with the commonly displayed multimedia content C1, the wearable devices may display personalized multimedia content to each of the first user, the second user and the third user. For example, the wearable device corresponding to the first user may display the multimedia content A1 corresponding to the first user together with the multimedia content C1 in the first time slot. According to an embodiment, the multimedia content A1 and the multimedia content C1 may be simultaneously displayed in the first time slot. The ratio of the size between the multimedia content C1 and the multimedia content A1 may be adjusted as the time slot changes. For example, the size of the multimedia content A1 may be gradually increased by changing the time slot. Similarly, the wearable device corresponding to the second user may display the multimedia content A2 corresponding to the second user together with the multimedia content C1. The wearable device corresponding to the third user may display the multimedia content A3 corresponding to the third user together with the multimedia content C1. The size may vary depending on the shape of an object (e.g., the external object 530 of FIG. 5 and/or the virtual object 730 of FIG. 7) on which multimedia content is displayed. For example, in case that the multimedia contents are simultaneously displayed on the external object 530 of FIG. 5, the size may indicate the size occupied by each of the multimedia content in one surface of the external object 530. A method of simultaneously displaying different multimedia contents is not limited to the example of FIG. 10B.

Referring to an exemplary state 1003 of FIG. 10C, the server connected to the wearable devices of the first user, the second user and the third user may adaptively adjust the order of multimedia content displayed through each of the wearable devices, depending on whether the multimedia content is displayed through the wearable devices. For example, in a time interval 1010 including the third to fifth time slots, the first user may use an application different from the application (e.g., a multimedia content output application 670 of FIG. 6) for displaying the multimedia content, by using the wearable device corresponding to the first user. In case that the display of the multimedia content by the wearable device corresponding to the first user is stopped by the different application, the server may sequentially transmit multimedia contents B23-1, B23-2, and B23-3 corresponding to a cluster including the second user and the third user who are possible to access the multimedia content, to wearable devices corresponding to the second user to the third user. Based on identifying that from the sixth time slot after the time interval 1010, all of the first user, the second user and the third user are possible to access to the multimedia content, the server may resume display of multimedia content based on a cluster including all of the first user, the second user and the third user, with wearable devices corresponding to the first user, the second user and the third user.

As described above, according to an embodiment, the server connected to electronic devices (e.g., the wearable devices of the first user, the second user and the third user) may schedule the order of multimedia contents to be displayed through the electronic devices based on time and/or space.

FIG. 11 illustrates an example of a flowchart including a wearable device 510 and an operation of a server 110 connected to the wearable device 510 according to an embodiment. An operation of the wearable device 510 of FIG. 11 may be performed by the wearable device 510 illustrated in FIGS. 5, 6, and 7 and/or a processor 610 of the wearable device 510 of FIG. 6. The operation of the server 110 of FIG. 11 may be performed by the server 110 of FIGS. 5, 6 and 7 and/or the processor 615 of the server 110 of FIG. 6. In the following embodiment, each operation may be performed sequentially, but is not necessarily performed sequentially. For example, the order of each operation may be changed, and at least two operations may be performed in parallel. Moreover, according to an embodiment, one or more operations illustrated in FIG. 11 may be omitted and one or more other operation may be added.

Referring to FIG. 11, in operation 1110, according to an embodiment, the wearable device 510 may request multimedia content associated with an object to server 110, based on identifying the object. The object may be a preset or predetermined object. The wearable device 510 may be a device worn by a first user. The wearable device 510 may perform the operation 1110 based on execution of a multimedia content requester 672 of FIG. 6. The preset object may include an object set by the server 110 for selective display of multimedia content, such as an external object 530 of FIG. 5 and/or a virtual object 730 of FIG. 7. For example, the wearable device 510 may request multimedia content associated with the preset object to server 110, based on identifying that the preset object is included in FoV of a user (e.g., a user 530 of FIG. 5) wearing the wearable device 510.

Referring to FIG. 11, in operation 1120, according to an embodiment, the server 110 may obtain a degree of association between the first user of the wearable device 510 and a second user different from the first user and browse the multimedia content based on the preset object. According to an embodiment, the server 110 may obtain a degree of association between the first user of the wearable device 510 and a plurality of second user different from the first user and browse the multimedia content based on the preset object. The degree of association may include the virtual distance described above with reference to Equation 1. For example, the server 110 may calculate virtual distances between different users (e.g., the first user and the second users) accessing the preset object.

Referring to FIG. 11, in operation 1130, according to an embodiment, the server 110 may identify a cluster matched to each of the first user and the second user, based on the degree of association. For example, the server 110 may identify a group associated with each of the first user and the second user, based on the degree of association. One or more clusters (or groups) may be matched to (or associated with) a specific user. A specific cluster may be matched to one or more multimedia contents. The server 110 may create the cluster by grouping users having a relatively high degree of association based on the degree of association between the first user and the second users. For example, the degree of association may be represented by a numerical value, and the server may create the cluster by grouping users having the degree of association greater than a reference value. However, the disclosure, is not limited thereto, and as such, according to an embodiment, the server may create multiple clusters, each based on a different degree of association. For example, a first cluster may be formed by grouping users having the degree of association greater than a first reference value, and a second cluster may be formed by grouping users having the degree of association greater than a second reference value. According to an embodiment, the first cluster and the second cluster may include, but is not limited to, one or more overlapping users. The server 110 may perform operations 1120 and 1130 based on the execution of a cluster manager 682 of FIG. 6.

Referring to FIG. 11, in operation 1140, according to an embodiment, the server 110 may transmit the multimedia content to the wearable device corresponding to each of the first user and the second user, based on the identified cluster. In case that a plurality of multimedia contents correspond to the specific cluster, the server 110 may transmit the order in which the plurality of multimedia contents are displayed together with the multimedia content, as described above with reference to FIGS. 10A, 10B, and 10C. Based on operation 1140, the wearable device 510 may receive information for displaying at least one multimedia content from the server 110. The server 110 may perform operations 1130 and 1140, based on the execution of a multimedia content scheduler 683 and/or a multimedia content transmitter 684 of FIG. 6.

Referring to FIG. 11, in operation 1150, according to an embodiment, the wearable device 510 may output the multimedia content received from the server 110 to the first user of the wearable device 510. The wearable device 510 may visualize the multimedia content in the FoV of the first user by using a display (e.g., a display 630 of FIG. 6). The embodiment is not limited to this, and the wearable device 510 may output an audio signal included in the multimedia content to the first user by using a speaker, or may output haptic feedback included in the multimedia content to the first user by using a haptic actuator. The wearable device 510 may perform operation 1150, based on execution of a multimedia content output device 674 of FIG. 6.

FIG. 12 illustrates an example of a flowchart including an operation of an electronic device, according to an embodiment. The operation of the electronic device of FIG. 12 may be performed by a server 110 of FIG. 5 to FIG. 7 and/or a processor 615 of the server 110 of FIG. 6. The operation of FIG. 12 may be performed in a state in which the electronic device executes a multimedia content providing application 680 of FIG. 6. In the following embodiment, each operation may be performed sequentially, but is not necessarily performed sequentially. For example, the order of each operation may be changed, and at least two operations may be performed in parallel.

Referring to FIG. 12, in operation 1210, according to an embodiment, the electronic device may identify clusters corresponding to a first external electronic device based on identifying that the first external electronic device accessing a position or a location in the real world or the virtual world. The position may be a preset position or a target position. According to an embodiment, the first external electronic device accessing the preset position may mean that the first external electronic device is able to access content provided at the preset position or the first external electronic device is present at the preset position, is present in the vicinity of the preset position or is able to view the present position. However, the disclosure is not limited thereto, and as such, other criteria may be used to determine if the first external electronic device is accessing the position. The preset position includes a position of an object preset for displaying multimedia content in the real world, such as an external object 530 of FIG. 5, and/or a position of a virtual object (e.g., a virtual object 730 of FIG. 7) preset for displaying multimedia content in a virtual space (e.g., a virtual space 710 of FIG. 7).

Referring to FIG. 12, in operation 1220, according to an embodiment, the electronic device may transmit first information for outputting first multimedia content corresponding to the first cluster in association with the preset position to the first external electronic device, based on the first cluster among clusters corresponding to the first external electronic device. Based on the first information, the first external electronic device (e.g., a wearable device 510 of FIGS. 5 to 7) may display the first multimedia content in association with the preset position. For example, if an object such as the external object 530 of FIG. 5 and/or the virtual object 730 of FIG. 7 is provided in the preset position, the first external electronic device may display the first multimedia content in association with the object.

Referring to FIG. 12, in operation 1230, according to an embodiment, the electronic device may identify a second external electronic device accessing the preset position. Before identifying the second external electronic device (1230—NO), the electronic device may maintain transmitting the first information for outputting the first multimedia content to the first external electronic device based on the operation 1220.

In an embodiment, in response to identifying the second external electronic device (1230—YES), based on operation 1240, the electronic device may identify a second cluster included in the clusters corresponding to the first external electronic device among the clusters corresponding to the second external electronic device. For example, the electronic device may identify the second cluster including the first external electronic device and the second external electronic device in common.

Referring to FIG. 12, in operation 1250, according to an embodiment, the electronic device may transmit second information for outputting second multimedia content corresponding to the second cluster in association with the preset position, to the first external electronic device and the second external electronic device, based on the second cluster. Based on the operation 1250, both the first external electronic device and the second external electronic device may output the second multimedia content based on the second information. Based on the operations 1230, 1240, and 1250, the electronic device may provide users of the first external electronic device and the second external electronic device with a user experience of displaying substantially matched multimedia content in association with the preset position.

FIG. 13 illustrates an example of a flowchart including an operation of a server connected to a wearable device, according to an embodiment. The operation of the server of FIG. 13 may be performed by a server 110 of FIGS. 5, 6 and 7 and/or a processor 615 of the server 110 of FIG. 6. The operation of the server 110 of FIG. 13 may be performed in a state in which a multimedia content providing application 680 of FIG. 6 is executed. In the following embodiment, each operation may be performed sequentially, but is not necessarily performed sequentially. For example, the order of each operation may be changed, and at least two operations may be performed in parallel.

Referring to FIG. 13, in operation 1310, according to an embodiment, the server may display a first visual object associated with a preset position shown through FoV of a first user wearing the wearable device (e.g., a wearable device 510 of FIGS. 5, 6 and 7). The preset position may include at least one of the position of the object preset for displaying the multimedia content in the real world, such as an external object 530 of FIG. 5, and/or the position of the object preset for displaying the multimedia content in a virtual space (e.g., a virtual space 710 of FIG. 7), such as a virtual object 730 of FIG. 7. As described above with reference to FIG. 7, the first visual object may be displayed in association with the object provided at the preset position. The first visual object may be included in the multimedia content corresponding to a cluster including the first user.

Referring to FIG. 13, in operation 1320, according to an embodiment, the server may identify whether a connection between the wearable device and an external electronic device has been established. Before a connection between the wearable device and the external electronic device is established (1320—NO), based on the operation 1310, the server may maintain displaying the first visual object by using the wearable device.

Referring to FIG. 13, in a state in which the connection between the wearable device and the external electronic device is established (1320—YES), in operation 1330, according to an embodiment, the server may obtain a state of the external electronic device based on the connection between the wearable device and the external electronic device. The connection between the wearable device and the external electronic device may be established for interaction between the first user of the wearable device and a second user of the external electronic device, such as a call connection.

Referring to FIG. 13, in operation 1340, according to an embodiment, the server may determine whether the state of the external electronic device corresponds to the preset state associated with the preset position. The preset state may include a state capable of displaying the multimedia content based on the preset position. For example, in case that the external electronic device has a form factor of the wearable device, the preset state may include a state in which the second user of the external electronic device wears the external electronic device and includes the preset position in the FoV of the second user. In case that the state of the external electronic device does not correspond to the preset state (1340—NO), the server may maintain monitoring the state of the external electronic device based on the operation 1330.

In an embodiment, in case that the state of the external electronic device corresponds to the preset state (1340—YES), based on operation 1350, the server may identify a cluster common to the second user and the first user of the external electronic device. The server may identify the cluster common to the second user and the first user based on the virtual distance between the second user and the first user. The virtual distance may be reduced by establishing connection of the operation 1320.

Referring to FIG. 13, in operation 1360, according to an embodiment, the server may transmit information for adjusting the first visual object shown through the FoV to the second visual object indicated by the identified cluster, to the wearable device in the operation 1310. Similarly, the server may transmit information for displaying the second visual object to the external electronic device. The second visual object may be included in the multimedia content corresponding to the cluster identified based on the operation 1350. Based on the above information, both the wearable device in the operation 1310 and the external electronic device in the operation 1320 may display the second visual object included in the multimedia content corresponding to the cluster in the operation 1350. Based on the second visual object, the server may provide a substantially matched user experience to the first user and the second user.

As described above, according to an embodiment, the wearable devices may obtain the multimedia content to be displayed to users of the wearable devices by communicating with the server. The server may classify the users based on a physical distance between the users and/or an interaction history between the users. The server may adjust the multimedia content to be displayed to each of the users based on a result of classifying the users. For example, with wearable devices corresponding to specific users who are closely interacting with each other, among the users, the server may provide multimedia content different from other wearable devices.

A method of adaptively changing multimedia content to be displayed by using a wearable device according to a state of a user wearing the wearable device may be required. As described above, according to an embodiment, a wearable device (e.g., a wearable device 510 of FIGS. 5, 6 and 7) may comprise a display (e.g., a display 630 of FIG. 6), a communication circuit (e.g., a communication circuit 650 of FIG. 6), and a processor (e.g., a processor 610 of FIG. 6). The processor may be configured to display a first visual object associated with a position viewed through field-of-view (FoV) of a first user wearing the wearable device by controlling the display. The processor may be configured to while the first visual object is displayed in the FoV through the display, obtain, based on identifying an external electronic device connected to the wearable device through the communication circuit, a state of the external electronic device. The processor may be configured to identify, based on obtaining the state of the external electronic device corresponding to a preset state for displaying a visual object associated with the position, a cluster common to the first user and a second user of the external electronic device. The processor may be configured to adjust, based on the identified cluster, the first visual object viewed through the FoV to a second visual object indicated by the cluster. According to an embodiment, the wearable device may adjust the visual object and/or the multimedia content to be displayed to the user based on the cluster for classifying the user.

For example, the processor may be configured to display the first visual object based on another cluster different from the cluster common to the first user and the second user, among a plurality of clusters assigned to the first user.

For example, the processor may be configured to, based on identifying the external electronic device, adjust a degree of association of the first user and the second user used for selective activation of the plurality of clusters. The processor may be configured to identify a cluster common to the first user and the second user from the plurality of clusters based on the adjusted degree of association.

For example, the processor may be configured to, among the plurality of clusters assigned to the first user, identify the cluster common to the first user and the second user based on at least one of a distance between the first user and the second user, interaction history between the first user and the second user.

For example, the interaction history may comprise at least one of an interaction between the first user and the second user indicated by a social-network-service, or call connection history between the first user and the second user.

For example, the processor may be configured to display a third visual object for synchronizing a visual object displayed by external electronic devices of distinct users accessible to the position and by the electronic device. The processor may be configured to obtain, based on identifying an input indicating to select the third visual object, the cluster common to the first user and the second user.

For example, the processor may be configured to request, to second external electronic device different from the external electronic device that is the first external electronic device, information for displaying the second visual object associated with the cluster.

For example, the processor may be configured to adjust, in response to identifying a release of connection between the wearable device and the external electronic device based on the communication circuit, the second visual object displayed in the FoV to the first visual object.

For example, the electronic device may comprise a camera provided toward the FoV. The processor may be configured to identify, based on frames output from the camera, a portion in the FoV corresponding to the position. The processor may be configured to display the first visual object by controlling the display by using the identified portion in the FoV.

As described above, according to an embodiment, a method of an electronic device may comprise identifying (e.g., operation 1210 of FIG. 12), based on identifying a first external electronic device accessing to a preset position for selectively outputting multimedia content through a communication circuit of the electronic device, clusters corresponding to the first external electronic device. The method may comprise, based on a first cluster from the identified clusters, transmitting (e.g., operation 1220 of FIG. 12), to the first external electronic device, information for outputting first multimedia content associated with the preset position, and corresponding to the first cluster. The method may comprise, in a state transmitting the first multimedia content to the first external electronic device, identifying (e.g., operation 1240 of FIG. 12), based on identifying a second external electronic device accessing to the preset position, clusters corresponding to the second external electronic device. The method may comprise, based on identifying second cluster included in the clusters corresponding to the first external electronic device among the clusters corresponding to the second external electronic device, transmitting (e.g., operation 1250 of FIG. 12), to the first external electronic device and the second external electronic device, information for outputting second multimedia content associated with the preset position and corresponding to the second cluster.

For example, the identifying the clusters corresponding to the first external electronic device may comprise identifying, based on account information of a first user logged in the first external electronic device, the clusters corresponding to the first external electronic device.

For example, the transmitting the information for outputting the first multimedia content may comprise transmitting, to the first external electronic device, the information for projecting the first multimedia content in a field-of-view (FoV) of a first user wearing the first external electronic device that is a wearable device.

For example, the identifying the clusters corresponding to the first external electronic device may comprise identifying, in response to receiving information indicating that the preset position is viewed through the FoV of the first user from the first external electronic device, the clusters corresponding to the first external electronic device.

For example, the identifying the second cluster may comprise identifying the second clusters based on at least one of a distance between the first external electronic device and the second external electronic device or interaction history between a first user of the first external electronic device and a second user of the second external electronic device.

For example, the transmitting the information for outputting the second multimedia content may comprise transmitting, based on whether modes of the first external electronic device and the second external electronic device is corresponding to a mode for synchronizing multimedia content associated with the preset position, the information for outputting the second multimedia content to the first external electronic device and the second external electronic device.

As described above, according to an embodiment, a method of a wearable device may comprise displaying a first visual object associated with a position viewed through field-of-view (FoV) of a first user wearing the wearable device through a display of the wearable device. The method may comprise, while the first visual object is displayed in the FoV through the display, obtaining, based on identifying an external electronic device connected to the wearable device through a communication circuit of the wearable device, a state of the external electronic device. The method may comprise identifying, based on obtaining the state of the external electronic device corresponding to a preset state for displaying a visual object associated with the position, a cluster common to the first user and a second user of the external electronic device. The method may comprise adjusting, based on the identified cluster, the first visual object viewed through the FoV to a second visual object indicated by the cluster.

For example, the displaying may comprise displaying the first visual object based on another cluster different from the cluster common to the first user and the second user from a plurality of clusters assigned to the first user.

For example, the identifying may comprise adjusting, based on identifying the external electronic device, a degree of association of the first user and the second user used for selective activation of the plurality of clusters. The identifying may comprise identifying a cluster common to the first user and the second user from the plurality of clusters based on the adjusted degree of association.

For example, the identifying may comprise, among the plurality of clusters assigned to the first user, identifying the cluster common to the first user and the second user based on at least one of a distance between the first user and the second user, interaction history between the first user and the second user.

For example, the method may comprise adjusting, in response to identifying a release of connection between the wearable device and the external electronic device based on the communication circuit, the second visual object displayed in the FoV to the first visual object.

As described above, according to an embodiment, an electronic device may comprise a communication circuit and a processor. The processor may be configured to identify, based on identifying a first external electronic device accessing to a preset position for selectively outputting multimedia content through a communication circuit, clusters corresponding to the first external electronic device. The processor may be configured to, based on a first cluster from the identified clusters, transmit, to the first external electronic device, information for outputting first multimedia content associated with the preset position, and corresponding to the first cluster. The processor may be configured to, in a state transmitting the first multimedia content to the first external electronic device, identify, based on identifying a second external electronic device accessing to the preset position, clusters corresponding to the second external electronic device. The processor may be configured to, based on identifying second cluster included in the clusters corresponding to the first external electronic device among the clusters corresponding to the second external electronic device, transmit, to the first external electronic device and the second external electronic device, information for outputting second multimedia content associated with the preset position and corresponding to the second cluster.

For example, the processor may be configured to identify the clusters corresponding to the first external electronic device, based on account information of a first user logged in the first external electronic device.

For example, the processor may be configured to transmit, to the first external electronic device, the information for projecting the first multimedia content in a field-of-view (FoV) of a first user wearing the first external electronic device that is a wearable device.

For example, the processor may be configured to identify, in response to receiving information indicating that the preset position is viewed through the FoV of the first user from the first external electronic device, the clusters corresponding to the first external electronic device.

For example, the processor may be configured to identify the second clusters based on at least one of a distance between the first external electronic device and the second external electronic device or interaction history between a first user of the first external electronic device and a second user of the second external electronic device.

The apparatus described above may be implemented as a combination of hardware components, software components, and/or hardware components and software components. For example, the devices and components described in the embodiments may be implemented using one or more general purpose computers or special purpose computers such as processors, controllers, arithmetical logic unit (ALU), digital signal processor, microcomputers, field programmable gate array (FPGA), PLU (programmable logic unit), microprocessor, any other device capable of executing and responding to instructions. The processing device may perform an operating system OS and one or more software applications performed on the operating system. In addition, the processing device may access, store, manipulate, process, and generate data in response to execution of the software. For convenience of understanding, although one processing device may be described as being used, a person skilled in the art may see that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, code, instruction, or a combination of one or more of them and configure the processing device to operate as desired or command the processing device independently or in combination. Software and/or data may be embodied in any type of machine, component, physical device, computer storage medium, or device to be interpreted by a processing device or to provide instructions or data to the processing device. The software may be distributed on a networked computer system and stored or executed in a distributed manner. Software and data may be stored in one or more computer-readable recording media.

The method according to the embodiment may be implemented in the form of program instructions that may be performed through various computer means and recorded in a computer-readable medium. In this case, the medium may continuously store a computer-executable program or temporarily store the program for execution or download. In addition, the medium may be a variety of recording means or storage means in which a single or several hardware are combined and is not limited to media directly connected to any computer system and may be distributed on the network. Examples of media may include magnetic media such as hard disks, floppy disks and magnetic tapes, optical recording media such as CD-ROMs and DVDs, magneto-optical media such as floppy disks, ROMs, RAMs, flash memories, and the like to store program instructions. Examples of other media include app stores that distribute applications, sites that supply or distribute various software, and recording media or storage media managed by servers.

Although embodiments have been described according to limited embodiments and drawings as above, various modifications and modifications are possible from the above description to those of ordinary skill in the art. For example, even if the described techniques are performed in a different order from the described method, and/or components such as the described system, structure, device, circuit, etc. are combined or combined in a different form from the described method or are substituted or substituted by other components or equivalents, appropriate results may be achieved.

Therefore, other implementations, other embodiments, and equivalents to the claims fall within the scope of the claims to be described later.

What is claimed is:

1. A wearable device, comprising:
a display;
a communication circuit; and
a processor configured to:
control the display to display a first visual object associated with a position viewed through field-of-view (FoV) of a first user wearing the wearable device;
obtain a state of a first external electronic device connected to the wearable device through the communication circuit, the first external electronic device associated with a second user;
identify, based on the state of the first external electronic device corresponding to a first state for displaying a visual object associated with the position, a first cluster common to the first user and the second user; and
control the display, based on the identified first cluster, to change from displaying the first visual object viewed through the FoV to display a second visual object corresponding to by the first cluster.

2. The wearable device of claim 1, wherein the processor is further configured to:
display the first visual object based on a second cluster different from the first cluster common to the first user and the second user, among a plurality of clusters associated with the first user.

3. The wearable device of claim 2, wherein the processor is further configured to:
based on identifying the first external electronic device, adjust a degree of association of the first user and the second user used for selective activation of the plurality of clusters;
identify the first cluster common to the first user and the second user from the plurality of clusters based on the adjusted degree of association.

4. The wearable device of claim 1, wherein the processor is further configured to:
among the plurality of clusters associated with the first user, identify the first cluster common to the first user and the second user based on at least one of a distance between the first user and the second user, interaction history between the first user and the second user.

5. The wearable device of claim 4, wherein the interaction history comprises:
at least one of an interaction between the first user and the second user in a social-network-service, communication history, or call connection history between the first user and the second user.

6. The wearable device of claim 1, wherein the processor is further configured to:
display a third visual object for synchronizing a visual object displayed by a plurality of external electronic devices of different users accessible to the position and by the electronic device;
obtain, based on identifying an input indicating to select the third visual object, the first cluster common to the first user and the second user.

7. The wearable device of claim 1, wherein the processor is further configured to:
request information for displaying the second visual object associated with the first cluster from a second external electronic device different from the first external electronic device.

8. The wearable device of claim 1, wherein the processor is further configured to:
control the display, based on release of connection between the wearable device and the first external electronic device, to change from displaying the second visual object displayed in the FoV to display the first visual object.

9. The wearable device of claim 1, further comprises a camera provided toward the FoV,
wherein the processor is further configured to:
identify, based on frames obtained from the camera, a portion in the FoV corresponding to the position;
control the display to display the first visual object based on the identified portion in the FoV.

10. A method of an electronic device, comprising:
obtaining, based on identifying a first external electronic device accessing to a first position for outputting multimedia content through a communication circuit of an electronic device, a plurality of first clusters corresponding to the first external electronic device;
transmitting, to the first external electronic device, information for outputting first multimedia content associated with the first position and corresponding to a first cluster among the plurality of first clusters;
obtaining, based on identifying a second external electronic device accessing to the first position, a plurality of second clusters corresponding to the second external electronic device;
based on identifying a second cluster commonly included in the plurality of first clusters and the plurality of second clusters, transmitting, to the first external electronic device and the second external electronic device, information for outputting second multimedia content associated with the first position and corresponding to the second cluster.

11. The method of claim 10, wherein the identifying the plurality of first clusters corresponding to the first external electronic device comprises:
identifying, based on account information of a first user logged in the first external electronic device, the plurality of first clusters corresponding to the first external electronic device.

12. The method of claim 10, wherein the transmitting the information for outputting the first multimedia content comprises:
transmitting, to the first external electronic device, the information for projecting the first multimedia content in a field-of-view (FoV) of a first user wearing the first external electronic device, which is a wearable device.

13. The method of claim 12, wherein the obtaining the plurality of first clusters corresponding to the first external electronic device comprises:
obtaining, based on receiving information indicating that the first position is viewed through the FoV of the first user from the first external electronic device, the plurality of first clusters corresponding to the first external electronic device.

14. The method of claim 10, wherein the identifying the second cluster comprises:
identifying the second cluster based on at least one of a distance between the first external electronic device and the second external electronic device or interaction history between a first user of the first external electronic device and a second user of the second external electronic device.

15. The method of claim 10, wherein the transmitting the information for outputting the second multimedia content comprises:
transmitting, based on whether modes of the first external electronic device and the second external electronic device is corresponding to a mode for synchronizing multimedia content associated with the first position, the information for outputting the second multimedia content to the first external electronic device and the second external electronic device.

16. A method of a wearable device, comprising:
displaying a first visual object associated with a position viewed through field-of-view (FoV) of a first user wearing the wearable device through a display of the wearable device;
obtaining a state of a first external electronic device connected to the wearable device through a communication circuit, the first external electronic device associated with a second user;
identifying, based on the state of the first external electronic device corresponding to a first state for displaying a visual object associated with the position, a first cluster common to the first user and the second user of the external electronic device; and
changing, based on the first cluster, from displaying the first visual object viewed through the FoV to displaying a second visual object corresponding to the first cluster.

17. The method of claim 16, wherein the displaying comprises:
displaying the first visual object based on a second cluster different from the first cluster common to the first user and the second user from a plurality of clusters associated with the first user.

18. The method of claim 17, wherein the identifying comprises:
adjusting, based on identifying the external electronic device, a degree of association of the first user and the second user used for selective activation of the plurality of clusters;
identifying the first cluster common to the first user and the second user from the plurality of clusters based on the adjusted degree of association.

19. The method of claim 16, wherein the identifying comprises:
among the plurality of clusters associated with the first user, identifying the first cluster common to the first user and the second user based on at least one of a distance between the first user and the second user, interaction history between the first user and the second user.

20. The method of claim 16, further comprises:
changing, based on release of connection between the wearable device and the external electronic device based on the communication circuit, from displaying the second visual object in the FoV to displaying the first visual object.
